(19) United States
(12) Patent Application Publication
(10) Pub. No.: US 2026/0057372 A1
(43) Pub. Date: Feb. 26, 2026

(54) ALTERING TIME SPENT IN A QUEUE USING POTENTIAL CHANGES IN TIME AND EXCHANGE AMOUNTS GENERATED BY A MACHINE LEARNING MODEL

(71) Applicant: American Express Australia Limited, Sydney (AU)

(72) Inventors: Lucky BIMOLAKSONO, Sydney (AU); Dean Ernest Arthur NICOLSON, Sydney (AU)

(73) Assignee: American Express Australia Limited, Sydney (AU)

(21) Appl. No.: 18/813,758

(22) Filed: Aug. 23, 2024

(51) Int. Cl. G06Q 20/36; G06F 3/04842

(52) U.S. Cl. CPC G06Q 20/36; G06F 3/04842

(57) ABSTRACT

Disclosed herein are system, apparatus, device, method and/or computer program product embodiments, and/or combinations and sub-combinations thereof, for altering the time spent in a queue for a respective exchange amount. This may include using user application data to predict and/or identify potential preferences for exchanging queue positions and/or determining potential changes in time spent in the queue. A queue exchange machine learning model may determine one or more potential changes in time and/or respective exchange amounts for each potential change in time. The exchange of queue positions may include vehicles traveling on a roadway and exchanging positions in traffic, exchanging positions between mobile device users standing in a line, and/or exchanging positions in an electronic queue. Monetary funding may be transferred between the queuing devices when exchanging positions in the queue.

### BACKGROUND

### Field

This field is generally related to managing queue preferences and the position of queuing devices based on collected data.

### Related Art

As technology continues to evolve and as society becomes increasingly fast-paced, different individuals may have different desires for how they wish to spend their time. One issue that many time-sensitive individuals face is waiting in a queue or waiting in traffic. Such individuals would view time spent in a queue or in traffic as a time sink or a waste of time. These individuals may wish to avoid and/or minimize the amount of time spent in the queue or in traffic. This issue may become even more pronounced as autonomous vehicles become more widely adopted. For example, users in autonomous vehicles may join queues in order to travel to their desired destinations.

In contrast, less time-sensitive individuals may be willing to wait for a longer amount of time in the queue or in traffic if incentivized to do so. Currently, there are no known mechanisms or technological solutions for reducing the time spent in a queue or in traffic or balancing the different interests of individuals. Further, there are no mechanisms in place to facilitate the exchange of queue positions and/or to facilitate transactions between devices exchanging positions.

### BRIEF SUMMARY

Disclosed herein are system, apparatus, device, method and/or computer program product embodiments, and/or combinations and sub-combinations thereof, for altering and/or changing the time spent in a queue using respective exchange amounts. A queue exchange machine learning model may determine a predicted time spent in a queue, one or more potential changes in time spent in the queue, and one or more exchange amounts respectively corresponding to each of the one or more potential changes in time spent in the queue. The queue exchange machine learning model may use user application data to determine these values. The user application data may include using input data, from the user or associated applications, to determine potential changes in time spent in the queue and corresponding respective exchange amounts for each potential change in time. The change in time spent in the queue many be an decrease in the time spent in the queue and corresponding compensation to another user for the exchange in position. In some embodiments, an increase in the time spent in the queue may correspond to the receipt of compensation for the exchange in position.

In some embodiments, a queuing device and/or a queue management system applies user application data to a queue exchange machine learning model to determine one or more potential changes in time and/or one or more respective exchange amounts. For example, the queue exchange machine learning model may determine that saving five minutes may correspond to an exchange amount of five dollars while saving ten minutes may correspond to an exchange amount of twenty dollars. The queue exchange machine learning model may derive these values via the collection of user application data from one or more computing devices participating in a queue. The user application data may be manually input by the user or retrieved from data sources associated with the queue, such as calendar data, traffic data, location data, and/or queue application data. The queue exchange machine learning model may generate a predicted time spent in the queue, one or more potential changes in time spent in the queue, and corresponding exchange amounts for the respective potential changes in time spent in the queue. The range of potential changes in time may be displayed to the user in the form of a dial or spectrum represented on a graphical user interface. An interaction may select the change in time spent in the queue and respective exchange amount.

Once the change in time spent in the queue and respective exchange amount has been selected, the queuing device and/or the queue management system may facilitate transactions and/or microtransactions between queuing devices associated with users in the queue. These transactions may correspond to one or more portions of the exchange amount which contribute to the change in time spent in the queue. The transactions between the queuing devices may be microtransactions, which may include transactions in which the transaction amount is lower than the processing cost. The transactions may also include transaction amounts that are equal to or higher than the processing cost. A transaction amount may be decided upon between the queuing devices to trade relative positions. This position trading may occur in different contexts. For example, the queuing devices may be located in vehicles and trade relative geographical positions along a road or highway. In some embodiments, the queuing devices may be communication devices capable of being held by a user in a physical line, such as ticket line, ride line, checkout line, and similar physical queuing lines where users may trade positions in the physical line. For example, the queuing devices may be a user device such as a mobile communication device, personal digital assistant (PDA), or another suitable portable or wearable communication device. In some embodiments, the position trading may be in the form of an electronic queue. The trading of positions may be a numeric position in the queue. For example, this may apply in an electronic ticketing system where users are attempting to purchase tickets to an event.

Once the users have traded positions in the queuing environment, a transaction occurs between the queuing devices and/or queue system accounts corresponding to the queuing devices. The transaction between the queuing devices are settled once a verified movement has occurred. The change in position may be determined based on the context of the queuing environment. For example, when detecting a relative physical change in position, verification of the movement may be based on a physical measurement. This physical change in location may be, for example, when one queuing device moves in front of another queuing device. In an electronic queue, a numeric consideration may be used to identify the change in position. For example, one queuing device moves to a lower, more advantageous, numerical value in the queuing environment. The change in position may be verified by each queuing device participating in the exchange, queuing devices not participating in the exchange, and/or the queue management system. Following verification of the movement and/or the change in position, the queuing devices may conduct a transaction to transfer value in exchange for the change in queue position.

### BRIEF DESCRIPTION OF THE DRAWINGS

The accompanying drawings are incorporated herein and form a part of the specification.

FIG. 1A depicts a block diagram of a physical queuing environment, according to some embodiments.

FIG. 1B depicts a block diagram of an electronic queuing environment, according to some embodiments.

FIG. 2A depicts a flowchart illustrating a method for queue management at a first queuing device based on a movement relative to a second queuing device in a physical queue, according to some embodiments.

FIG. 2B depicts a flowchart illustrating a method for queue management at a second queuing device based on a movement relative to a first queuing device in a physical queue, according to some embodiments.

FIG. 3 depicts a flowchart illustrating a method for queue management using a user interface on a queuing device, according to some embodiments.

FIG. 4 depicts a flowchart illustrating a method for queue management of an electronic queue, according to some embodiments.

FIG. 5 depicts a flowchart illustrating a method for queue management based on potential changes to an amount of time spent in a queue and corresponding respective exchange amounts, according to some embodiments.

FIG. 6 depicts a flowchart illustrating a method for updating a change in time or exchange amount selection, according to some embodiments.

FIG. 7 depicts a flowchart illustrating a method for facilitating an exchange of positions with one or more queuing devices based on a selected change in time spent in a queue, according to some embodiments.

FIG. 8 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for managing positions in a queue and settling transactions after a verified relative movement in position has occurred. Embodiments also provide for the altering and/or changing of the time spent in a queue using respective exchange amounts. A queue exchange machine learning model generates one or more potential changes in time spent in the queue and/or one or more exchange amounts respectively corresponding to each of the one or more potential changes in time spent in the queue. A user may select one or more of these options to alter the amount of time spend in a queue.

In some embodiments, queuing devices may settle transactions based on an exchange of queue position. This may include a physical change in relative queue position between queuing devices and/or an exchange of queue position in an electronic queue. Upon exchanging queue positions, the queuing devices may conduct a transaction to transfer value for the exchanged queue position.

To facilitate the transactions, a queuing device may load a user's queue system account. The queue system account may be stored in an account database managed by the queue management system and/or include user preferences, payment information associated with a digital wallet service, and identifying information of the queuing device. The user of the queuing device may have previously registered with the queue management system.

After registration, the user may log into the queue system account via a user interface of the queuing management system. The previous user preferences, payment information, and/or queuing device identifier may then be loaded into the memory of the queuing device. The user preferences may be modified at the user interface of the queuing device. The queuing device may also allow the user to indicate the queue they are joining with the queuing device. In some embodiments, the queuing device and/or the queuing management system may use GPS information, position sensor data, and/or detection data from other queuing devices to determine a queue for a particular queuing device. The user may automatically join the detected and/or suggested queue.

The queue management system may use the user preferences, position data, and/or queue information as inputs for the user suggestion system. The user suggestion system may suggest the queuing device exchange positions in the queue with another queuing device in the same queue, for a suggested transaction amount. The suggested transaction amount may be determined by the queue management system based on the user preferences associated with the queuing device and queue system account. Additionally, the transaction may be a microtransaction to allow multiple successive transactions and/or exchanges in position in the queue with various other queuing devices in the same queue. Microtransactions may allow the queuing device to increase the position in the queue multiple times by exchanging positions with multiple different users.

The suggested exchange in position and corresponding transaction amount may be manually accepted by the user at the user interface of the queuing device or the user may allow the queuing device to automatically accept suggestions. The user may toggle on and off manual or automatic acceptance of suggestions at the user interface. The toggle may allow the user to change preferences while in the queue if desired.

Once the transaction amount is accepted, the queuing devices may exchange positions in the queue. To determine when the exchange in position occurs for physical queuing devices, sensors of the queuing device may be used. For example, a first queuing device may exchange positions with a second queuing device. The exchange in position can be confirmed by the first queuing device, second queuing device, or both queuing devices, depending on user preference. In some embodiments, the verification method may depend on the type of queue and/or the queuing environment. For example, the user of the second queuing device may indicate whether their queuing device should confirm the exchange in position or rely solely on the determination by the first queuing device. The queuing device may automatically determine when the exchange in position occurs by using existing sensors or infrastructure of the queuing device to determine when the exchange occurs. Additionally, the user may indicate that they would like to manually confirm when the exchange in position has occurred at the user interface of the queuing device. As similarly described above, the user can toggle between automatic and manual confirmation of the exchange in position via the user interface. In some embodiments, the queuing devices may use the same or separate modes of verification. For example, the first queuing device may use an automatic determination while the second queuing device may use a manual or automatic determination or may choose to rely on the determination of the first queuing device. Additionally, other queuing devices in the queue that are not associated with the specific transaction may determine whether the exchange in position has occurred and communicate the determination to the queue management system via the network.

In some embodiments, the queuing devices may communicate directly with each other using the communication interface or communicate via the network, depending on the type of queue environment and user preference. In some embodiments, the queuing devices may not communicate directly. Instead, the queuing devices may communicate with a queue management system. The queue management system may monitor the relative movement and/or positions of the queuing devices and/or facilitate the transactions.

In some embodiments, after the queuing device determines the exchange in position in the queue has occurred, the transaction amount is settled between the queuing devices. Transactions may be settled through a digital wallet service. The queue system account associated with the queuing device may include digital wallet information. When the user registers or logs into their queue system account at the user interface of the queuing device, the queue system account information may be loaded into the device memory of the corresponding queuing device. The queuing devices may settle the transaction in real-time. In some embodiments, the queuing devices may exchange digital wallet information and the transaction may be settled at a later time. For example, transactions may be settled when the queuing device has reached a particular point in the queue. An example of such a point may be once the queuing device has reached the front of a physical or electronic line or queue. In a vehicle, the settlement may occur when the queuing device has reached a particular destination and/or has connected to the queue management system via a network.

In an embodiment, the value exchanged between the digital wallets may be in the form of a digital currency. A digital currency is a form of money that exists only in electronic form and is not backed by any physical commodity or legal tender. Digital currencies may be advantageous because they typical involve very low, near zero, transaction fees. These very low transaction fees may enable micro-transactions to take place. Digital currencies can be created, stored, transferred, and exchanged using cryptography, peer-to-peer networks, and software protocols. Some examples of digital currencies are cryptocurrencies, such as Bitcoin and Ethereum, which operate on decentralized and distributed ledgers, and stablecoins, which are pegged to other assets or currencies to reduce volatility.

A central bank digital currency (CBDC) is a type of digital currency that is issued and regulated by a central bank as a legal tender and a liability of the central bank. A CBDC can be designed to have similar features and functions as cash, such as accessibility, anonymity, and finality, or to have additional capabilities, such as programmability, traceability, and interoperability. A CBDC can be implemented using different technologies and architectures, such as token-based or account-based, centralized or decentralized, wholesale or retail, and online or offline. Some examples of CBDC projects are the digital yuan in China, the e-krona in Sweden, and the sand dollar in the Bahamas.

In some embodiments, the queue may be a physical queue (e.g. a queuing device in a physical line) In some embodiments, the queue may be an electronic queue (e.g. a queue for online sales). In the electronic queuing environment, the queuing devices may communicate via the network, as they are not in physical proximity to one another. Additionally, the exchange in position in the queue may be verified by queue management system rather than direct verification from the queuing devices.

Various embodiments of these features will now be discussed with respect to the corresponding figures.

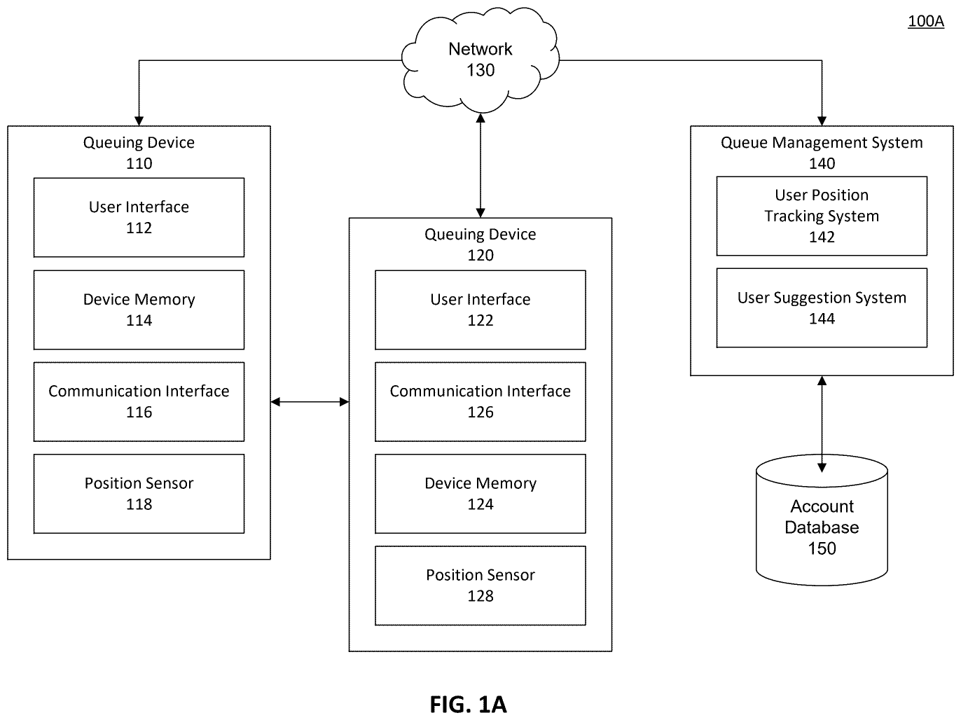

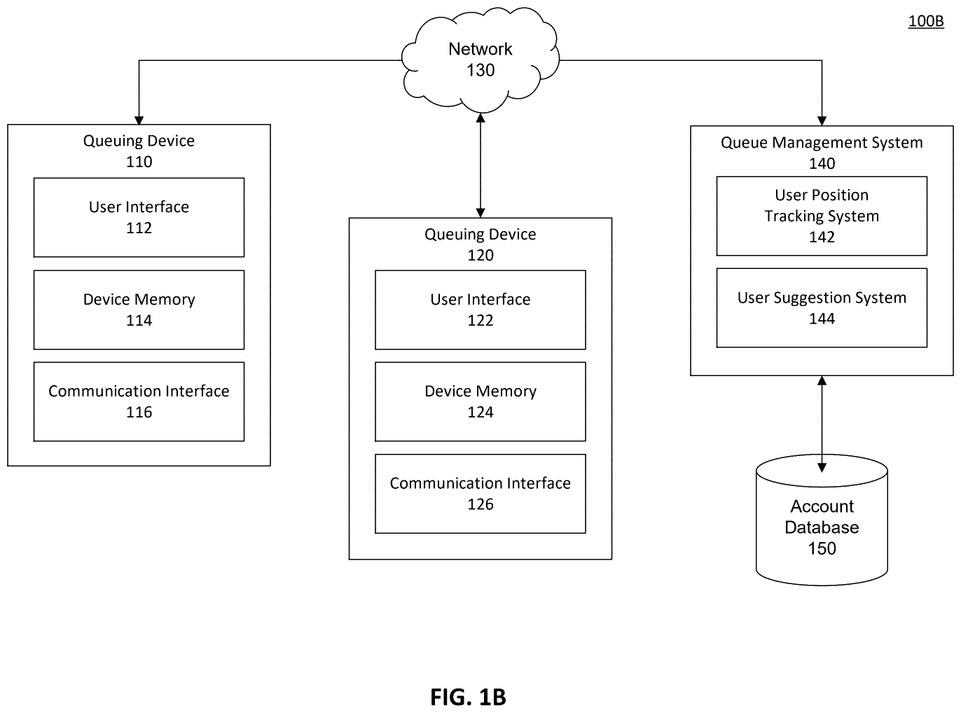

FIG. 1A depicts a block diagram of a physical queuing environment 100A, according to some embodiments. Physical queuing environment 100A includes queuing devices 110 and 120, network 130, queue management system 140, and account database 150.

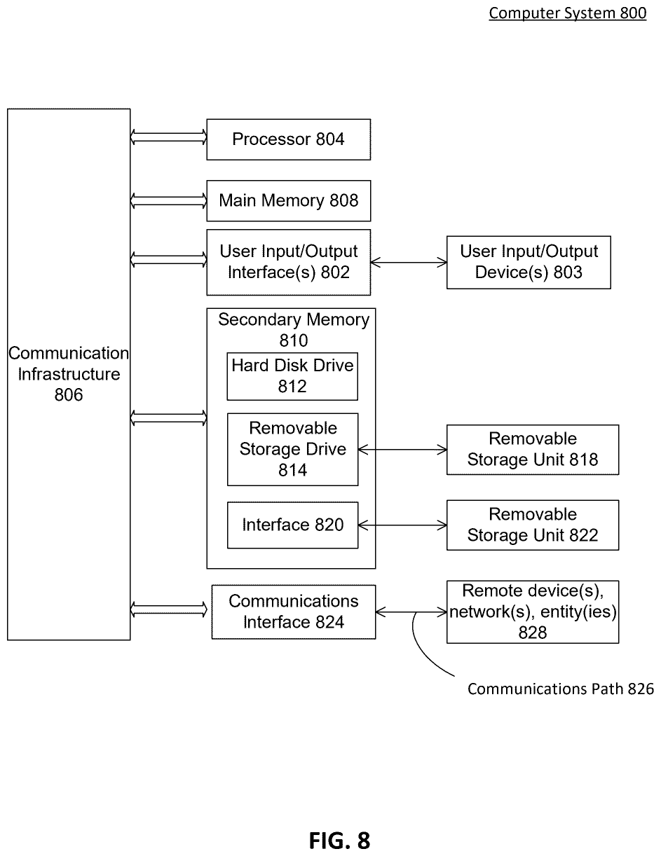

In physical queuing environment 100A, queuing devices 110 and 120 may be a computer system such as computer system 800 described with reference to FIG. 8. For example, queuing devices 110 and 120 may be a vehicle computer system, smart phone, smart watch, laptop or notebook computer, netbook, tablet, personal digital assistant (PDA), and/or other mobile communication devices which are wearable or portable. Queuing devices 110 and 120 may include user interface 112 and 122, device memory 114 and 124, communication interface 116 and/or 126, and position sensor 118 and 128, respectively.

In some embodiments, the user registers a queue system account or logs into an existing queue system account on queuing devices 110 and 120. The queue system account is managed by queue management system 140 and stored in account database 150. Once the user has registered or logged in to the queue system account, the queue system account is loaded at the corresponding queuing device and account information is temporarily stored in device memory 114 and 124. Account information temporarily stored in device memory 114 and 124 may include user preferences, payment information associated with a digital wallet, and queuing device identifiers. The user may update the user preferences before entering the queue or while the queuing device is in the queue, at user interface 112 and 122. The user preferences indicate to queue management system 140 the conditions the user would like to have met in order to exchange positions in the queue with second queuing device 120. The conditions may include factors such as time and cost. The queue system account for each user may store identifying information, such as name, email, address, account number. Additionally, the queue system account may store identifying information of the queuing device that can be transmitted to another queuing device to confirm an exchange in position in the queue. This queuing device identifying information may include license plate number, driver's license number, registration number, device serial number, or similar forms of identifying information. For example, queuing device identification information may also include physical location and/or relative position information. Users may provide consent to the information that is recorded and/or stored.

In some embodiments, queuing devices 110, 120 may be a dedicated device. For example, this may be a wearable device that may be persistent and/or bound to a user. This may include a theme park wristband, a concert venue lanyard, and/or other wearable devices. In some embodiments, the queuing device 110, 120 may not use a login and/or verification process. Rather, queue management system 140 may use an identifier and/or credentials corresponding to the queuing device 110, 120 for identification.

Queuing devices 110 and 120 may also include device memory 114 and 124. Device memory 114 and 124 may store digital wallet service information associated with the queue system account. A digital wallet service may be used to settle a transaction between first queuing device 110 and second queuing device 120 after an exchange in position in the queue has occurred between queuing devices 110 and 120. Device memory 114 and 124 may include payment information, passwords, transaction encryption keys, and/or communication encryption keys associated with the digital wallet service information associated with the corresponding queue system account (e.g., associated with a user of the queue system account). For example, the digital wallet may include payment card information. The payment card may be associated with a primary account number (PAN). According to some aspects of this disclosure, the PAN may be tokenized for security. According to some aspects of this disclosure, the PAN associated with the queue system account may be stored by account database 150. According to some aspects of this disclosure, monetary assets may be transferred between payment accounts associated with the digital wallet service information stored in device memory 114 and 124. For example, digital wallet service information may identify a digital wallet. The digital wallet may correspond to a blockchain wallet, asset account, financial account, Central Bank Digital Currency (CBDC) wallet, government and/or state issued digital wallet, private wallet, business wallet, and/or other digital account capable of settling transactions, such as microtransactions. These transactions may occur and/or be settled in real-time.

In some embodiments, communication interfaces 116 and 126 facilitate communication between first queuing device 110 and second queuing device 120. This may occur as direct wireless communications between the queuing devices 110 and 120 and/or may occur via network 130. Additionally, communication interfaces 116 and 126 may facilitate communication between queuing devices 110 and 120 and queue management system 140, via network 130. In some embodiments, communication interfaces 116 and 126 may also be used in a mesh network to route communications between a queueing devices 110 and 120 and queue management system 140. For example, first queuing device 110 may communicate with queue management system 140 via other queueing devices. These other queuing devices may pass connection and data from first queuing device 110 to queue management system 140. These other queueing devices may or may not include second queueing device 120. For example, in a system where second queueing device 120 is a counterparty to a transaction, there may be less trust between the two queuing devices 110, 120. First queuing device 110 may be wary that second queueing device 120 could modify and/or alter communications for their benefit. In this case, if first queuing device 110 communicates with queue management system 140 via a mesh network configuration, first queuing device 110 may transmit communications to other queuing devices (not pictured). Queuing devices 110, 112 may communicate with other queuing devices and/or queue management system 140 via communication interfaces 116 and 126. Communication interfaces 116 and 126 may use a communication protocol (e.g., Ultra-wideband (UWB), Wi-Fi Direct, peer-to-peer Wi-Fi, Nearby Share, Multipeer Connectivity, infrared, etc.) to facilitate a peer-to-peer, ad hoc, and high-speed network) to facilitate communication between queuing devices 110 and 120. Ultra-wideband is a radio technology that can use a very low energy level for short-range, high-bandwidth communications over a large portion of the radio spectrum. In some embodiments, the communication protocol may be a low latency/high-speed peer-to peer-connection. utilizing a peer-to-peer connection reduces the network resources required to accommodate various queuing environment that might have a large volume of queuing devices in a single queue, such as vehicles on a highway.

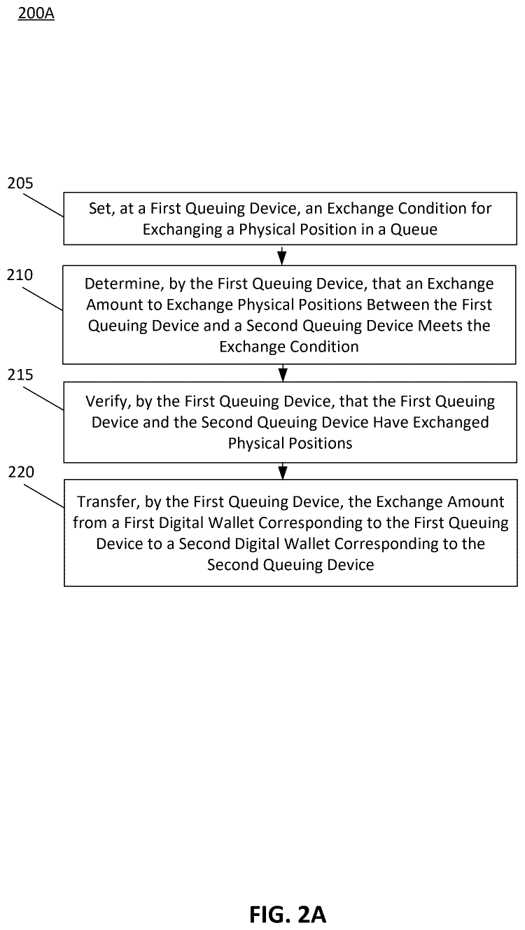

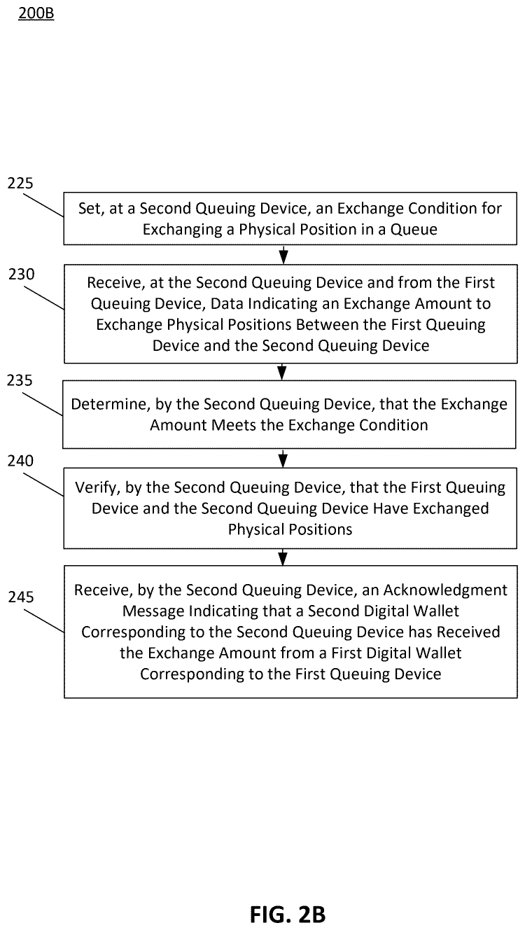

In some embodiments, first queuing device 110 is detected and/or identified via the communication module 126 of second queuing device 120, and vice versa. First queuing device 110 may transmit a queuing device identifier to second queuing device 120, and vice versa. As described in greater detail later herein in reference to FIGS. 2A, 2B, 3, and 4, the identifier associated with queuing devices 110 and 120 may be tokenized and/or may depend on the type of environment queuing system 100 is operating in. For example, in a highway based queuing system the tokenized identifier may be a license plate number, transponder, driver's license number, registration number, and/or other vehicle identifier.

For example, if the user preference indicates the user will manually determine first queuing device 110 has exchanged positions in the queue with second queuing device 120, then the queuing device identifier may be a visual identifier such as a license plate number. The user may confirm that first queuing device 110 has exchanged positions with second queuing device 120 by recognition of the queuing identifier. The user may then supply an input to user interface 122 to confirm the exchange. The same process may also be used for queuing device 110 to determine the exchange in position with second queuing device 120. In this case, user interface 112 and communication interface 116 may be used.

Position sensors 118 and 128 may use the available infrastructure of queuing devices 110 and 120 to autonomously verify a change in relative position. Data from position sensors 118 and 128 may indicate an exchange in position in the queue has occurred. For example, in a highway based queuing system position sensor 118 may access the sensor system (e.g. the blind spot detection system using ultrasonic or radar sensors, self-driving cars using LIDAR, front, rear, side or 360 degree cameras, or a combination of these sensors or systems used in vehicles) of the first queuing device 110 (e.g. user vehicle) to determine when second queuing device 120 (e.g. another user vehicle) has changed position in queuing environment 100 relative to first queuing device 110. Position sensor 118 can verify the relative movement of first queuing device 120 relative to second queuing device 110 in queuing environment 100. Similarly, position sensor 128 can verify the relative movement of second queuing device 110 relative to first queuing device 120 in queuing environment 100. For example, in a highway based queuing system, position sensor 118 may use the existing sensor infrastructure of the vehicle to verify the relative movement of second queuing device 120 relative to first queuing device 110. In queuing environment 100A, the relative movement may be a measurable distance because the queue is a physical queue. For example, the queue may be formed with vehicles on a highway or users with queuing devices in a physical line.

In some embodiments, communication interfaces 116 and 126 may enable position sensors 118 and 128 to communicate detected information between queuing devices 120 and 110, respectively. Queuing devices 110 and 120 may have a queuing device identifier. The queuing device identifier may be associated with the corresponding queue system account and stored in queue system account database 150. When the transaction amount is accepted for queuing devices 110 and 120, queue management system 140 may transmit the queuing device identifier corresponding to first queuing device 110 to second queuing device 120 and the queuing device identifier corresponding to second queuing device 120 to queuing device 110. When the exchange in position occurs, communication interface 116 transmits the queuing device identifier of queuing device 110 to queuing device 120. Queuing device 120 in turn confirms that the transmitted queuing device identifier is the same queuing device identifier queuing device 120 received from queue management system 140. The same process can also be executed by queuing device 110.

For example, the exchange in position in the queue of queuing devices 110 and 120 may be automatically confirmed by queuing devices 110 and 120 using communication interfaces 116 and 126 and position sensors 118 and 128. Communication interfaces 116 and 126 may transmit the queuing device identifier and position sensors 118 and 128 may verify the change in position in the queue by using the existing sensors and infrastructure of queuing devices 110 and 120 to determine when another queuing device is moving position relative to first queuing device 110 or second queuing device 120.

In some embodiments, queuing device 110 may use a different method than queuing device 120 to determine a change in relative movement has occurred and there was an exchange in position in the queue. For example, first queuing device 110 may use communication interface 116 and position sensor 118 to automatically confirm the change in relative position between queuing devices 110 and 120. Queuing device 120 may use position sensor 128 to determine there was a change in relative movement and use communication interface 126 to manually confirm that the change in relative position between queuing device 110 and queuing device 120. Additionally, queue management system 140 may request, via network 130, other queuing devices in queuing environment 100 that are not involved in the transaction to verify the relative movement of one or both of queuing devices 110 and 120 to determine that an exchange in position in the queue occurred.

In some embodiments, communication interfaces 116 and 126 may additionally enable peer-to-peer wireless transfer of the value of the transaction between queuing devices 110 and 120 using digital wallet service information stored in device memory 114 and 124. The transaction can be settled in real-time for the accepted transaction amount. In some embodiments, the transaction is a microtransaction. Microtransactions may allow the queuing devices 110, 120 to exchange position in the queue multiple times according to the user preferences indicated at user interface 112 and 122, respectively.

Communication interfaces 116 and 126 may also implement security protocols to provide secure identifiers, transaction information, and/or communications. Encryption, authentication, identity verification, and/or other security protocols would be used to ensure that queuing device identifiers being transmitted or used are accurate and/or legitimate. For example, the security protocols would provide protections against device identifiers being counterfeited, spoofed, replayed, and/or used without permission by bad actors.

Queue management system 140 manages the queue system accounts of various users. Users may register a queue system account with queue management system 140 via network 130. In addition to the user preferences and queuing device identifier, user payment information may be associated with the queue system account. The user may register one or more bank accounts to the queue system account and/or provide parameters specifying usage of each of the one or more bank accounts. The bank account information may be associated with a digital wallet service. The digital wallet information may be transmitted to queuing devices 110 and 120 when the users login at queuing devices 110 and 120, respectively. In some embodiments, the digital wallet service may link the queue system account to a virtual card token in queue management system 140.

In some embodiments, queuing devices 110 and 120 may be associated with multiple queue system accounts. For example, the user can login to one or more devices capable of joining the queue and acting as a queuing device with the user's corresponding queue system account.

In some embodiments, queue management system 140 may implement countermeasures to prevent Sybil attacks and/or other attacks where a malicious actor attempts to create a large number of identities or accounts. For example, queue management system 140 may request a valid funding source and/or a nominal registration fee when registering a queue system account. The fee may be a microtransaction. This may discourage a threat actor from attempting to register hundreds or thousands of accounts. For example, the threat actor may face rapidly mounting costs that may discourage them from creating fake accounts. This may make the process economically unfeasible in terms of cost and time. In some embodiments, queue management system 140 may also use functional identity attestations and/or confirmations to prevent threat actors.

Queue system account information associated with queuing devices 110 and 120 may be stored in account database 150. In some embodiments, queuing devices 110 and 120 may use software applications installed on queuing devices 110 and 120, respectively, to facilitate transmission of location and/or calendar information that may affect user preferences for the queue. For example, queuing devices 110 and 120 may share data with queue management system 140 from other applications installed on queuing devices 110 and 120, such GPS tracking applications or calendar applications.

Account database 150 stores queue system account information for each user and user preference data. This data may correspond to time preferences and/or may include timestamps indicating when queuing devices 110, 120 join a particular queue. The preferences may indicate when a queuing device 110, 120 is expected to join a queue. Account database 150 stores user preferences received at queue management system 140 from user interfaces 112 and 122. The information associated with the queue system account may be accessed each time queuing devices 110 and 120 connects to queue management system 140 via network 130. In some embodiments, device memory 114 and 124 may be persistent and/or store queue system account information in a persistent manner as well. In some embodiments, the account information may also include user history and/or information corresponding to previous usage of a queuing device 110, 120 and/or queue management system 140. Queue management system 140 may also track usage metrics, engagement scores, loyalty program data, and/or user status tiers. For example, a high usage user may be granted a VIP tier or designation. In some embodiments, queue management system 140 may adjust price calculations and/or queue prioritization for users based on the user's history and/or usage metrics.

Queue management system 140 may include user position tracking system 142 and/or user suggestion system 144. User position tracking system 142 tracks the position of each queuing device in queuing environment 100A. User position tracking system 142 may receive data from applications installed on queuing devices 110 and 120. User suggestion system 144 may use the position data from user position tracking system 142 and user preferences to suggest a queue for a particular queuing device to join and/or to suggest a potential exchange of position between first queuing device 110 and second queuing device 120.

For example, the first queuing device 110 and/or the queuing management system 140 may use GPS information, position sensor data, and/or detection data from other queuing devices to determine a queue for the first queuing device 110. In some embodiments, queue management system 140 queries first queuing device 110 for location and/or position information. Queue management system 140 may use this information to suggest a particular queue and/or to place first queuing device 110 into a particular queue automatically. The user may automatically join and/or choose to join the detected and/or suggested queue. Queue management system 140 may also automatically place the first queuing device 110 in a particular position in the queue according to the location and/or position information. In some embodiments, queue management system 140 may also triangulate the position of the first queuing device 110 using data from other nearby queueing devices. This data may include positioning data and/or sensor data. For example, as further described in this disclosure, queue management system 140 may identify a starting position and/or queue for the first queuing device 110 using positioning data and/or sensor data similar to the data used to verify that positions have been exchanged between queuing devices. This may occur automatically.

User suggestion system 144 may additionally suggest transaction amount for the exchange of position in queuing environment 100. The suggested transaction amount may be based on the user preferences associated with the queue system accounts logged in at queuing devices 110 and 120. For example, user suggestion system 144 may suggest first queuing device 110 exchange position in the queue with second queuing device 120 for a specified dollar amount. The suggested dollar amount may depend on user preferences such as speed, time, economy, profit, cost, and/or other user-defined preferences. The user input preferences of first queuing device 110 and second queuing device 120 may contribute to the suggested transaction amount presented at user interface modules 112 and 122 from user suggestion system 144 of queue management system 140.

For example, the user preferences from user interface 112 of first queuing device 110 may indicate that the user has a short timeline and is willing to pay a certain transaction amount to increase their position in a queue. The user input preferences of second queuing device 120 may indicate that the user is not on a short timeline. For example, the user of second queuing device 120 does not need or does not have a desire to increase the position of second queuing device 120 in the queue. The second queuing device 120 may also include a desired profit amount for exchanging positions. In this case, if the desired profit for exchanging position in the queue is within the budget of queuing device 110, then suggestion module 144 may suggest a transaction amount to queuing devices 110 and 120 corresponding to second queuing device 120 yielding its position in the queue to first queuing device 110. In some embodiments, automated market maker (AMM) and/or a coincidence of wants (CoW) calculations, algorithms, and/or processes may be used as well.

The queuing environment 100 may include a network 130. Network 130 may be a wireless network and/or a combination of wired and wireless networks. For example, network 130 may include a packet-switched network (e.g., internet protocol-based network), a non-packet switched network (e.g., quadrature amplitude modulation-based network), and/or the like. According to some aspects of this disclosure, network 130 may include network adapters, switches, routers, modems, and the like connected through wireless links (e.g., radiofrequency, satellite) and/or physical links (e.g., fiber optic cable, coaxial cable, Ethernet cable, or a combination thereof). According to some aspects of this disclosure, network 130 may include public networks, private networks, wide area networks (e.g., Internet), local area networks, and/or the like. According to some aspects of this disclosure, network 130 may provide and/or support communication from a telephone, cellular phone, modem, and/or other electronic devices associated with queuing devices 110 and 120 to and throughout the queuing environment 100. For example, queuing environment 100 may include and support communications between queuing management system 140 and queuing devices 110 and 120 via network 130.

FIG. 1B, depicts a block diagram of an electronic queuing environment 100B, according to some embodiments. Electronic queuing environment 100B includes queuing devices 110 and 120, network 130, queue management system 140, and account database 150.

Electronic queuing environment 100B may correspond to a scenario where queuing devices 110 form an electronic queue. For example, the electronic queue may correspond to ticket sales on a website. Users with corresponding queuing system accounts may be placed in a queue prior to being allowed to purchase tickets to a concert, show, sporting event, and/or other ticketed event. Queue management system 140 may manage the electronic queue to avoid overwhelming ticket system resources in ticket distribution. The users may use queuing devices 110, 120 to join the electronic queue and/or view their corresponding position in the queue. As further explained below, the users may use queuing devices 110, 120 to exchange positions in the queue. Queue management system 140 may facilitate transactions between queue system accounts to facilitate the exchange of monetary value for queue position between users of queuing devices 110, 120.

For example, queue management system 140 includes user position tracking system 142 and user suggestion system 144. User position tracking system 142 tracks the position of each account corresponding to the queuing devices in queuing environment 100B. User position tracking system 142 may manage the electronic queue, manage queue position information, and/or provide queue position information to queuing devices 110, 120. In some embodiments, queue management system 140 may facilitate exchanges of positions while a separate system facilitates the electronic queue. In this case, queue management system 140 may receive position information from the other system managing the electronic queue. For example, when the electronic queue is for ticket sales on a website, queue system 140 may communicate via network 130 with the electronic queue and the electronic queue may provide user position tracking system 142 of queue management system 140 position data for each of the queuing devices in the electronic queue. Network 130 may be similar to network 130 as described with reference to FIG. 1A.

In electronic queuing environment 100B, queuing devices 110 and 120 may be a computer system such as computer system 800 described with reference to FIG. 8. For example, queuing devices 110 and 120 may be a smart phone, smart watch, desktop computer, laptop or notebook computer, netbook, tablet, personal digital assistant (PDA), and/or other electronic devices that are capable of entering a digital queue. Queuing devices 110 and 120 may include user interface 112 and 122, device memory 114 and 124, communication interface 116 and 126, respectively. In some embodiments, the user registers a queue system account or logs into an existing queue system account on queuing devices 110 and 120. The queue system account is managed by queue management system 140 and stored in account database 150. Once the user has registered or logged in to the queue system account, the queue system account is loaded at the corresponding queuing device and account information is temporarily stored in device memory 114 and 124. Account information temporarily stored in device memory 114 and 124 may include user preferences, payment information associated with a digital wallet, and queuing device identifiers. The user may update the user preferences before entering the queue or while the queuing device is in the queue, at user interface 112 and 122. The user preferences indicate to queue management system 140 the conditions the user would like to have met in order to exchange positions in the queue with second queuing device 120. The conditions may include factors such as time and cost. The queue system account for each user may store identifying information, such as name, email, address, account number. Additionally, the queue system account may store identifying information of the queuing device that queue management system can use to confirm the exchange in position in the queue of queuing devices 110 and 120.

In some embodiments, the queue system account may also store and/or use queuing device identifying information in the context of ticket sales. For example, in the context of online ticket sales, this information may be used to determine an initial position of the user account and/or a price or priority for exchanging positions. In some embodiments, data may also be gathered from other systems and/or connections. For example, users may consent to having data gathered from a streaming service, such as a video or music streaming service, and/or from a social media platform. For example, if the user is a fan of a particular band or musical act, the data may be gathered to indicate fan may engagement. Such information may be used to provide preferential queue positions and/or may be used to provide different or cheaper exchange rates. For example, exchange rates for users trading positions may be modified based on the users' engagement with the particular band or musical act. This engagement may be measured based on the data gathered from the social media platforms and/or streaming services.

Device memory 114 and 124 may store digital wallet service information associated with the queue system account. A digital wallet service may be used to settle a transaction between first queuing device 110 and second queuing device 120 after an exchange in position in the queue has occurred between queuing devices 110 and 120. Device memory 114 and 124 may include payment information and passwords associated with the digital wallet service information associated with the corresponding queue system account (e.g., associated with a user of the queue system account). For example, the digital wallet may include payment card information. The payment card may be associated with a primary account number (PAN). According to some aspects of this disclosure, the PAN may be tokenized for security. According to some aspects of this disclosure, the PAN associated with the queue system account may be stored by account database 150. According to some aspects of this disclosure, monetary assets may be transferred between payment accounts associated with the digital wallet service information stored in device memory 114 and 124. For example, digital wallet service information may identify a digital wallet. The digital wallet may correspond to a blockchain wallet, asset account, financial account, and/or other digital account capable of settling transactions, such as microtransactions. These transactions may occur and/or be settled in real-time.

Communication interfaces 116 and 126 may facilitate communication between first queuing device 110 and queue management system 140 via network 130 and second queuing device 120 and queue management system 140 via network 130. Queue management system 140 may communicate changes in electronic queue position to queuing devices 110 and 120. Communication interfaces 116 and 126 may receive queue position information. Communication interfaces 116 and 126 may also receive digital wallet service information from queue management system 140 to settle the transaction between first queuing device 110 and second queuing device 120. In some embodiments, the communication between queuing devices 110, 120 and queue management system 140 may occur using network 130. This may use communications protocols in the manner described with reference to FIG. 1A.

For example, first queuing device 110 may exchange position in the queue with second queuing device 120. This may occur when an account corresponding to first queuing device 110 exchanges positions with an account corresponding to second queuing device 120. First queuing device 110 and second queuing device 120 may communicate the desire to exchange positions in the queue to queue management system 140. For example, queue management system 140 may transmit data to queuing device 110 to display a graphical user interface prompt. The prompt may provide an offer to the user to change positions in the electronic queue for a particular transaction and/or microtransaction fee or exchange. For example, the exchange may be exchange positions between accounts corresponding respectively to queuing devices 110 and 120. A first account corresponding to queuing device 110 may take the place of a second account corresponding to queuing device 120 in the electronic queue. A transaction amount may be transferred from the first account to the second account in response to this exchange of position. The change in position in the queue may be entered manually, for example the users first queuing device 110 and second queuing device 120 may confirm their desire to exchange positions in the queue via user interfaces 112 and 122. Queue management system 140 then exchanges the positions and/or verifies that they correctly exchanged position if the electronic queue is managed by a separate system. Additionally, queue management system 140 may autonomously verify the exchange in position, for example through the source code of the electronic queue or through communication with the electronic queue.

Queue management system 140 manages the queue system accounts of various users. User may register a queue system account with queue management system 140 via network 130. In addition to the user preferences and queuing device identifier, user payment in formation may be associated with the queue system account. The user may register one or more bank accounts to the queue system account and/or provide parameters specifying usage of each of the one or more bank accounts. The bank account information may be associated with a digital wallet service. The digital wallet information may be transmitted to queuing devices 110 and 120 when the users login at queuing devices 110 and 120, respectively. In some embodiments, the digital wallet service may link the queue system account to a virtual card token in queue management system 140.

In some embodiments, queuing devices 110 and 120 may be associated with multiple queue system accounts. For example, the user can login to one or more devices capable of joining the queue and acting as a queuing device with the user's corresponding queue system account.

Queue system account information associated with queuing devices 110 and 120 may be stored in account database 150. In some embodiments, queuing devices 110 and 120 may use software applications installed on queuing devices 110 and 120, respectively, to facilitate transmission of position and/or calendar information that may affect user preferences for the queue.

Account database 150 stores queue system account information for each user and user preference data. This data may correspond to time preferences and/or may include timestamps indicating when queuing devices 110, 120 join a particular queue. The preferences may indicate when a queuing device 110, 120 is expected to join a queue. Account database 150 stores user preferences received at queue management system 140 from user interfaces 112 and 122. The information associated with the queue system account may be accessed each time queuing devices 110 and 120 connects to queue management system 140 via network 130. In some embodiments, device memory 114 and 124 may be persistent and/or store queue system account information in a persistent manner as well.

Queue management system 140 may include user position tracking system 142 and user suggestion system 144. User position tracking system 142 tracks the position of each queuing device in queuing environment 100B. User position tracking system 142 may receive data from applications installed on queuing devices 110 and 120. Additionally, user position tracking system may receive queuing device position information from the electronic queue. For example, when the electronic queue is for ticket sales on a website, queue system 140 may communicate via network 130 with the electronic queue and the electronic queue may provide user position tracking system 142 of queue management system 140 position data for each of the queuing devices in the electronic queue.

User suggestion system 144 may use the position data from user position tracking system 142 and user preferences to suggest a potential exchange of position between first queuing device 110 and second queuing device 120. User suggestion system 144 may additionally suggest transaction amount for the exchange of position in electronic queuing environment 100B. The suggested transaction amount may be based on the user preferences associated with the queue system accounts logged in at queuing devices 110 and 120. For example, user suggestion system 144 may suggest first queuing device 110 exchange position in the queue with second queuing device 120 for a specified dollar amount. The suggested dollar amount may depend on user preferences such as time, economy, profit, cost, and/or other user-defined preferences. The user input preferences of first queuing device 110 and second queuing device 120 may contribute to the suggested transaction amount presented at user interface 112 and 122 from user suggestion system 144 of queue management system 140.

For example, the user preferences from user interface 112 of first queuing device 110 may indicate that the user has a short timeline and/or wishes to purchase tickets before they become unavailable. The preference may indicate a willingness to pay a certain transaction amount to increase their position in a queue. The user input preferences of second queuing device 120 may indicate that the user is not on a short timeline and/or has less of a desire to obtain tickets. For example, the user of second queuing device 120 does not need or does not have a desire to increase the position of second queuing device 120 in the queue. The second queuing device 120 may also include a desired profit amount for exchanging positions. In this case, if the desired profit for exchanging position in the queue is within the budget of queuing device 110, then suggestion module 144 may suggest a transaction amount to queuing devices 110 and 120 corresponding to second queuing device 120 yielding its position in the queue to first queuing device 110.

FIG. 2A depicts a flowchart illustrating a method 200A for queue management at a first queuing device based on a movement relative to a second queuing device in a physical queue, according to some embodiments. Method 200A shall be described with reference to FIG. 1A; however, method 200A is not limited to that example embodiment.

In an embodiment, first queuing device 110 may utilize method 200A to exchange positions in a physical queue 100A with second queuing device 120. For example, the queuing devices may be located in vehicles and trade relative geographical positions along a road or highway. In some embodiments, first queuing device 110 and second queuing device 120 may correspond to users standing in a queue. For example, such a queue may be at a theme park, at an event venue, at a grocery store, and/or other scenarios where uses may form a queue. First queuing device 110 and second queuing device 120 may trade positions in the queue when the users operating the first and second queuing devices 110, 120 exchange physical locations. The foregoing description will describe an embodiment of the method 200A with respect to the first queuing device 110. While method 200A is described with reference to first queuing device 110, method 200A may be executed on any computing device, such as, for example, second queuing device 120, or the computer system described with reference to FIG. 8 and/or processing logic that may comprise hardware (e.g., circuitry dedicated logic, programmable logic, microcode, etc.), software (e.g., instructions executing on a processing device), or combination thereof.

It is to be appreciated that not all steps may be needed to perform the disclosure provided herein. Further, some of the steps may be performed simultaneously, or in a different order than shown in FIG. 2A, as will be understood by a person of ordinary skill in the art.

At 205, first queuing device 110 sets an exchange condition for exchanging a physical position in a queue. In some embodiments, the exchange condition may be a parameter and/or condition indicating when first queuing device 110 will execute a transaction to exchange positions in a queue. For example, a user using first queuing device 110 may set a threshold monetary amount for exchanging positions with one or more other queuing devices. Upon approaching another queuing device, first queuing device 110 may check this threshold amount to determine whether to exchange positions. For example, a user may be willing to spend one dollar to exchange a position in a queue and/or to pass another vehicle in traffic. When approaching another vehicle and/or second queuing device 120, first queuing device 110 may perform a check of a condition set by the second queuing device 120 to determine whether to exchange positions. For example, if the second queuing device 120 has set a condition indicating an acceptance of one dollar or less to exchange positions in the queue, first queuing device 110 may recognize this as acceptable and meeting the exchange condition set by first queuing device 110. In some embodiments, the exchange condition may be set locally by first queuing device 110 and/or may be stored in memory residing on first queuing device 110.

When defining a threshold, this may be for each queuing device and/or may be an aggregate amount. The user may set a limit and/or cap on the amount to spend for the duration of the queue. For example, the user may indicate a desire to spend less than fifteen dollars to exchange positions with one or more other queuing devices in the queue.

In some embodiments, first queuing device 110 may have registered an account with queue management system 140. First queuing device 110 may define account information, which may include the exchange condition. This information may be retrieved from queue management system 140 when first queuing device 110 initializes an application installed on first queuing device 110.

In some embodiments, the exchange condition may be a recommendation and/or suggestion provided by queue management system 140. For example, a user may use a map routing application installed on first queuing device 110 to identify a particular destination for travel. First queuing device 110 may transmit the travel information to queue management system 140. First queuing device 110 may also transmit an amount of time the user wishes to spend in traffic. For example, traffic may indicate an approximate travel time of 45 minutes but the user may wish to avoid traffic and complete the trip in 35 minutes. First queuing device 110 may transmit this data to queue management system 140. Queue management system 140 may then return an estimated amount to be spent to accomplish this travel goal. For example, queue management system 140 may estimate that ten other vehicles will likely be passed and/or exchange positions with first queuing device 110 and that each exchange of position will correspond to a transfer of one dollar. In this case, queue management system 140 may provide an estimate of ten dollars and/or provide a range of values to the first queuing device 110 to accomplish the travel goal. The user may accept this estimate, which may correspond to setting the exchange condition. This may occur in the context of manually driven vehicles, autonomously driven vehicles, and/or users standing in a queue.

In some embodiments, queue management system 140 may use calendar application information to predict traffic and/or provide a suggestion to first queuing device 110. In this case, first queuing device 110 may set the exchange condition by accepting the suggested amount. Queue management system 140 may also use other application data and/or observed historical outcomes to aid in providing a suggested exchange condition and/or a time/cost suggestion.

At 210, first queuing device 110 determines that an exchange amount to exchange physical positions between the first queuing device 110 and a second queuing device 120 meets the exchange condition. In some embodiments, first queuing device 110, second queuing device 120, and/or queue management system 140 may determine the exchange amount. For example, the exchange amount may be set by the user and/or by first queuing device 110. For example, the user may have indicated that they are willing to exchange one dollar for exchanging positions with the second queuing device 120. First queuing device 110 may communicate this offer autonomously to second queuing device 120. This communication may occur in response to detecting that first queuing device 110 is approaching the second queuing device 120. For example, first queuing device 110 may determine that a distance between first queuing device 110 and second queuing device 120 meets or falls below a threshold. This communication may be manually provided by a user input on first queuing device 110 and/or may be automatically transmitted by first queuing device 110.

In some embodiments, second queuing device 120 may receive the offer and/or may transmit an acceptance message to first queuing device 110. As further described with reference to FIG. 2B, second queuing device 120 may include its own respective exchange condition for accepting the exchange of queue positions. Second queuing device 120 may transmit a message accepting the exchange amount determined by first queuing device 110.

In some embodiments, second queuing device 120 may provide an exchange amount to first queuing device 110. For example, second queuing device 120 may broadcast a message indicating that it is willing to exchange positions for a dollar. First queuing device 110 may then identify this exchange amount and/or compare the broadcasted exchange amount to the exchange condition set at the first queuing device 110. The first queuing device 110 may determine that this exchange amount is acceptable for exchanging physical positions.

When using queue management system 140, queue management system 140 may determine the exchange amount. For example, queue management system 140 may determine the exchange amount when first queuing device 110 is in the queue and/or prior to first queuing device 110 joining the queue. This may be, for example, when first queuing device 110 is using a trip planning application.

At 215, first queuing device 110 verifies that the first queuing device 110 and the second queuing device 120 have exchanged physical positions. After determining that the exchange amount is acceptable to first queuing device 110 and/or second queuing device 120, position sensors on first queuing device 110 and/or second queuing device 110 may be used to determine that a relative movement has occurred. For example, the position sensors may determine that first queuing device 110 has passed the second queuing device 120 in the queue. This may be passing vehicles in traffic and/or may include mobile devices passing in a line or queue. First queuing device 110 may perform this verification and/or may receive verification messages from one or more other devices. For example, second queuing device 120 may confirm that the relative movement has occurred. In some embodiments, other devices may also perform this confirmation. For example, smart city infrastructure and/or other position tracking systems may confirm the exchange of positions. First queuing device 110 may be informed of this positional data when verifying that the exchange has occurred.

At 220, first queuing device 110 transfers the exchange amount from a first digital wallet corresponding to the first queuing device 110 to a second digital wallet corresponding to the second queuing device 120. In some embodiments, first queuing device 110 may receive an identifier corresponding to the second digital wallet. For example, this identifier may be received from second queuing device 120 and/or from queue management system 140. Using the digital wallet identifier and/or the exchange amount, first queuing device 110 may initiate a transfer of the exchange amount to the second digital wallet. For example, first queuing device 110 may use a digital wallet exchange service. This may include a microtransaction service and/or a cryptocurrency service. In some embodiments, first queuing device 110 may wirelessly initialize this transfer via communications with queue management system 140. This may occur while first queuing device 110 is still positioned in the queue and/or after completing the queue.

In some embodiments, first queuing device 110 may generate a log of one or more queuing devices that exchanged positions while navigating the queue. This log may record one or more digital wallet identifiers and/or respective exchange amounts corresponding to the queuing devices that exchanged positions. Transferring the exchange amount may include transferring one or more exchange amounts to respective digital wallets corresponding to the one or more other queuing devices that exchanged positions with first queuing device 110. First queuing device 110 may initialize the transfer while first queuing device 110 is still positioned in the queue and/or after completing the queue. For example, first queuing device 110 may communicate with a digital wallet service and/or queue management system 140 to execute the transactions and/or transfers in the log. First queuing device 110 may transmit the one or more identifiers from the log to the digital wallet service to transfer the exchange amount.

FIG. 2B depicts a flowchart illustrating a method 200B for queue management at a second queuing device based on a movement relative to a first queuing device in a physical queue, according to some embodiments. Method 200B shall be described with reference to FIG. 1A; however, method 200B is not limited to that example embodiment.

In an embodiment, second queuing device 120 may utilize method 200B to exchange positions in a physical queue 100A with first queuing device 110. For example, the queuing devices may be located in vehicles and trade relative geographical positions along a road or highway. In some embodiments, first queuing device 110 and second queuing device 120 may correspond to users standing in a queue. For example, such a queue may be at a theme park, at an event venue, at a grocery store, and/or other scenarios where uses may form a queue. First queuing device 110 and second queuing device 120 may trade positions in the queue when the users operating the first and second queuing devices 110, 120 exchange physical locations. The foregoing description will describe an embodiment of the method 200B with respect to the second queuing device 120. While method 200B is described with reference to second queuing device 120, method 200B may be executed on any computing device, such as, for example, first queuing device 110, or the computer system described with reference to FIG. 8 and/or processing logic that may comprise hardware (e.g., circuitry dedicated logic, programmable logic, microcode, etc.), software (e.g., instructions executing on a processing device), or combination thereof.

It is to be appreciated that not all steps may be needed to perform the disclosure provided herein. Further, some of the steps may be performed simultaneously, or in a different order than shown in FIG. 2B, as will be understood by a person of ordinary skill in the art.

At 225, second queuing device 120 sets an exchange condition for exchanging a physical position in a queue. This may be similar to 205 as described with reference to FIG. 2A. For second queuing device 120, the exchange condition may correspond to a condition for yielding a position in a queue. For example, second queuing device 120 may set a condition for when second queuing device 120 will yield its position in the queue or in traffic to another queuing device, such as first queuing device 110. For example, the second queuing device 120 may set a condition indicating an acceptance of at least two dollars to exchange positions in the queue.

At 230, second queuing device 120 receives from the first queuing device 110 data indicating an exchange amount to exchange physical positions between the first queuing device 110 and the second queuing device 120. This may occur in a manner similar to 210 as described with reference to FIG. 2A. For example, the first queuing device 110 may transmit a message to second queuing device 120 indicating an exchange amount to take the position of second queuing device 120 in the queue. In some embodiments, second queuing device 120 may receive the exchange amount from queue management system 140.

At 235, second queuing device 120 determines that the exchange amount meets the exchange condition. This may occur in a manner similar to 210 as described with reference to FIG. 2A. Second queuing device 120 may determine that the first queuing device 110 is willing to provide a monetary payment to second queuing device 120 for exchanging positions in the queue. This determination may be made based on the exchange condition set by second queuing device 120.

At 240, second queuing device 120 verifies that the first queuing device 110 and the second queuing device 120 have exchanged physical positions. This may occur in a manner similar to 215 as described with reference to FIG. 2A. For example, second queuing device 120 and/or first queuing device 110 may use respective position sensors to verify that a relative movement occurred and/or that the positions have been exchanged. In some embodiments, other devices may also perform this confirmation. For example, smart city infrastructure and/or other position tracking systems may confirm the exchange of positions. Second queuing device 120 may be informed of this positional data when verifying that the exchange has occurred. In some embodiments, second queuing device 120 may transmit a message to first queuing device 110 and/or queue management system 140 indicating that it has verified the movement and/or has yielded the position in the queue.

At 245, second queuing device 120 receives an acknowledgement message indicating that a second digital wallet corresponding to second queuing device 120 has received the exchange amount from a first digital wallet corresponding to the first queuing device 110. In response to verifying that the movement has occurred, the first queuing device 110 may initiate a transfer of the exchange amount to the second digital wallet. This may occur in a manner similar to 220 as described with reference to FIG. 2A. Upon completion of the transfer via a digital wallet service, second queuing device 120 may receive a message from the digital wallet service indicating that the transfer of the exchange amount has been completed.

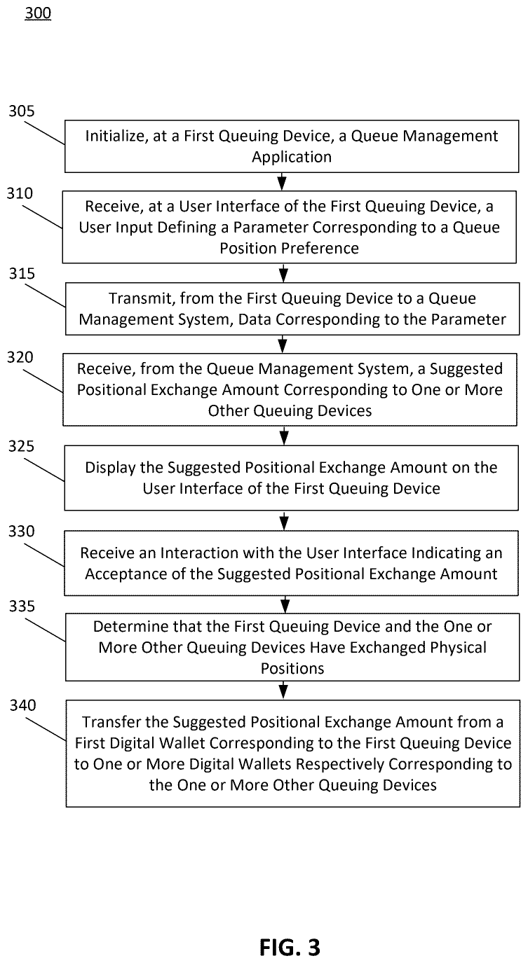

FIG. 3 depicts a flowchart illustrating a method 300 for queue management using a user interface on a queuing device, according to some embodiments. Method 300 shall be described with reference to FIG. 1A; however, method 300 is not limited to that example embodiment.

In an embodiment, first queuing device 110 may utilize method 300 to exchange positions in a physical queue 100A with second queuing device 120. For example, the queuing devices may be located in vehicles and trade relative geographical positions along a road or highway. In some embodiments, first queuing device 110 and second queuing device 120 may correspond to users standing in a queue. For example, such a queue may be at a theme park, at an event venue, at a grocery store, and/or other scenarios where uses may form a queue. First queuing device 110 and second queuing device 120 may trade positions in the queue when the users operating the first and second queuing devices 110, 120 exchange physical locations. The foregoing description will describe an embodiment of the method 300 with respect to the first queuing device 110. While method 300 is described with reference to first queuing device 110, method 300 may be executed on any computing device, such as, for example, second queuing device 120, or the computer system described with reference to FIG. 8 and/or processing logic that may comprise hardware (e.g., circuitry dedicated logic, programmable logic, microcode, etc.), software (e.g., instructions executing on a processing device), or combination thereof.

It is to be appreciated that not all steps may be needed to perform the disclosure provided herein. Further, some of the steps may be performed simultaneously, or in a different order than shown in FIG. 3, as will be understood by a person of ordinary skill in the art.

At 305, first queuing device 110 initializes a queue management application. For example, when first queuing device 110 corresponds to a vehicle, the initialization may correspond to powering on the vehicle and/or accessing a queue management application on a computing device of the vehicle. In some embodiments, the queue management application may be installed on a mobile device. The initialization may include a user accessing the application on the mobile device.

As part of the initialization process, first queuing device 110 may receive queue system account information from queue management system 140. The user of the first queuing device 110 may have previously registered with the queue management system 140. If the user of the first queuing device 110 has previously registered, the queue system account information may include user preferences, payment information associated with a digital wallet service, and/or identifying information of the first queuing device 110. If the user of the first queuing device 110 has not previously registered, there may be less queue system account information available from queue management system 140. In some embodiments, the user may perform a registration with queue management system 140 using first queuing device 110.

The first queuing device 110 may also receive queue system account information and/or may display the queue system account information at user interface 112. Queue management system 140 may transmit data capable of being displayed on a graphical user interface of user interface 112. This may include a previously stored user preference for exchanging queue positions.

At 310, first queuing device 110 receives, at user interface 112, a user input defining a parameter corresponding to a queue position preference. In some embodiments, the parameter may be defined by modifying a user preference previously stored by queue management system 140. The parameter indicates to queue management system 140 the conditions the user would like to have met in order to exchange positions in the queue with second queuing device 120. The conditions may include factors such as time and cost. For example, the parameter may include an amount of money a user wishes to spend to advance in a queue, a destination address, an amount of time the user would like to spend traveling, an amount of time the user would like to be in a queue and/or in traffic, and/or other data that may be used by queue management system 140 to determine a suggested exchange of positions. The parameter may be updated and/or managed as part of a trip planning application as previously described. The parameter may be updated in accordance with the user's desire in increase or decrease the position of first queuing device 110 in the physical queue. For example, the user may interact with one or more icons, fillable text boxes, drop-down menus, and/or other graphical user interface objects to define one or more parameters. Adjusting the parameters in the trip planning application may result in an increase or decrease of time spent in a queue.

In some embodiments, the graphical user interface may include a dial or a slider. This may include a moveable marker on a spectrum. The spectrum may depict a correlation between a particular length in time and a cost. For example, a user may select to pay a higher cost to spend less time in the queue. Similarly, a user may select a lower cost and/or choose to receive funding to spend more time in the queue.

At 315, first queuing device 110 transmits the parameter to queue management system 140. The transmitted parameter indicating the user trip planning preference may be the updated user preference if the user chose to modify the user preferences at user interface 112. If the user chose to keep the received user preferences received from queue management system 140 at 305, then an acknowledgment message and/or a copy of the original user preferences may be transmitted back to queue management system 140. Additionally, along with the updated user preference, first queuing device 110 may also allow the user to identify a particular queue that they are joining. For example, this may be reflected based on a destination when the user is traveling in a vehicle. In some embodiments, the queue may be a physical queue where a user is waiting in line. The parameter may indicate the line where the user is waiting.

At 320, first queuing device 110 receives a suggested positional exchange amount from queue management system 140 corresponding to one or more other queuing devices. For example, in the context of trip planning, the suggested positional exchange amount may reflect an estimated amount for exchanging queue positions with one or more other queuing devices in the queue. The suggested positional exchange amount may comprise one or more microtransactions. This may also similarly apply in the context of standing in a line or in a queue. The suggested positional exchange amount may be based on information received at user position tracking system 142 and/or user suggestion system 144 of queue management system 140. For example, user position tracking system 142 determines the position of first queuing device 110 and second queuing device 120 in the queue. User suggestion system 144 may suggest a transaction amount for the exchange of position in queuing environment 100A between first queuing device 110 and second queuing device 120. The suggested positional exchange amount may be based on the one or more parameters reflecting the user preferences transmitted to queue management system 140. The transaction amount may be for a particular monetary exchange and/or microtransaction fee or exchange.

For example, in a physical queue such as vehicles on a highway, there may be many vehicles registered with queue management system 140. Those vehicles both registered with queue management system 140 and traveling in the route of first queuing device 110, as determined by user position tracking system 142, may be the one or more queuing devices considered for an exchange in position by user suggestion system 144. User suggestion system 144 determines if the user preferences of other queuing devices in the queue indicate that they are willing to decrease or exchange their respective queue positions for a certain monetary value that matches the user preferences of first queuing device 110. User suggestion system 144 may then suggest an exchange in position on the highway between first queuing device 110 and the one or more other queuing device for a transaction amount matching the user preferences of the queuing devices. Second queuing device 120 may be an example of a queuing device from the one or more queuing devices.

At 325, first queuing device 110 may display the suggested positional exchange amount on the user interface 112 of the first queuing device 110. For example, first queuing device 110 may update the graphical user interface to display the data received from queue management system 140. The graphical user interface may also be updated to display an estimated time of arrival, a number of estimated queuing devices that will exchange queue positions, an identification of the one or more other queuing devices, and/or other data used to inform queue management. First queuing device 110 may also include one or more graphical user interface buttons or icons allowing a user to indicate an acceptance of the suggested positional exchange amount.

In some embodiments, the display and/or selection of a positional exchange amount may occur prior to a user operating a vehicle. For example, the user may select a positional exchange amount prior to embarking on a journey. In some embodiments, the display and/or selection may occur while the vehicle in motion. In this case, protections against distracting drivers may be implemented. For example, audio may be used and/or voice commands may be used to accept a suggested positional exchange amount. In some embodiments, a temporary screen lockout may occur to prevent a driver from shifting his or her focus to the user interface 112. The temporary screen lockout may occur when multiple interactions within a predetermined time window are detected. These measures to limit driver interactions while a vehicle is in motion may promote safety and/or minimize driver distractions.

At 330, first queuing device 110 may receive an interaction with the user interface 112 indicating an acceptance of the suggested positional exchange amount. User interface 112 may display a prompt on a graphical user interface. In some embodiments, in response to first queuing device 110 accepting the transaction amount and the corresponding exchange in position, queue management system 140 may request second queuing device 120 to accept the exchange in position with first queuing device 110 and the suggested positional exchange amount as well. If first queuing device 110 does not accept the exchange in position or transaction amount, queue management system 140 may suggest another transaction amount. Additionally, using user interface 112, the user preferences may be updated. For example, user preferences may be updated to indicate first queuing device 110 no longer has a preference to exchange positions in the queue or increase the value first queuing device 110 is willing to transfer in order to increase the position in the queue.

The user preferences may be updated via user interface 112 after queue management system 140 suggests an exchange in position to first queuing device 110. Additionally, user preferences may be updated while first queuing device 110 is in a queue. The updated user preferences may be transmitted from first queuing device 110 to queue management system 140 through network 130. User suggestion system 144 may modify the suggested positional exchange amount in accordance with the update user preference data before suggesting an exchange in position.

At 335, first queuing device 110 may determine that the first queuing device 110 and the one or more other queuing devices have exchanged physical positions. This may occur in a manner similar to 215 as described with reference to FIG. 2A. For example, position sensors 118 on first queuing device 110 may gather data used to determine when the relative movement has occurred. Position sensor 118 may use the existing sensor infrastructure of the vehicle to verify the relative movement of second queuing device 120 relative to first queuing device 110. In queuing environment 100A, the relative movement may be a measurable distance because the queue is a physical queue. For example, in a highway based queuing system position sensor 118 may access the sensor system (e.g. the blind spot detection system using ultrasonic or radar sensors, self-driving cars using LIDAR, front, rear, side or 360 degree cameras, or a combination of these sensors or systems used in vehicles) of the first queuing device 110 (e.g. user vehicle) to determine when second queuing device 120 (e.g. another user vehicle) has changed position in queuing environment 100 relative to first queuing device 110. Additionally, second queuing device 120 may also confirm that a relative movement has occurred such that first queuing device 110 has changed position in queuing environment 100A relative to second queuing device 120.

In the context of standing in a line or in a queue, sensors on the mobile devices may be used to determine relative distance and/or an exchange in position. In some embodiments, another system, such as an infrastructure system or smart city system may also track the relative positions of first queuing device 110 and second queuing device 120. In some embodiments, prompts may be displayed on first queuing device 110 and second queuing device 120. The relative movement and/or exchange of position may be verified when users of first queuing device 110 and second queuing device 120 have indicated and/or confirmed the exchange of position using the prompts.

At 340, first queuing device 110 transfers the suggested positional exchange amount from a first digital wallet corresponding to the first queuing device 110 to one or more digital wallets respectively corresponding to the one or more other queuing devices. This may occur in a manner similar to 220 as described with reference to FIG. 2A. For example, first queuing device 110 may issue a command to a digital wallet service to transfer the suggested positional exchange amount. In some embodiments, the second queuing device 120 may be one of the one or more queuing devices. The transaction may be settled between first queuing device 110 and second queuing device 120 for the transaction amount accepted between the queuing devices. The transaction may be a microtransaction, which may allow first queuing device 110 to continue to exchange positions and/or transact with additional queuing devices in the queue. In some embodiments, at 305, payment information may have been received at first queuing device 110 and/or temporarily stored on device memory 114. For example, the payment information may be digital wallet information associated with the queue system account. Communication interfaces 116 and 126 may allow the transaction to be settled in real-time. Stored digital wallet service information may be exchanged via communications interfaces 116 and 126. For example, communication interfaces 116 and 126 may communicate via network 130 and/or settle the transaction in real-time. Additionally, the exchange of information may occur offline via a peer-to-peer network. For example, first queuing device 110 may log and/or record transactions while traversing the queue. First queuing device 110 may settle the transactions at the conclusion of the queue. In some embodiments, first queuing device 110 may communicate with a digital wallet service and/or queue management system 140 to execute the transactions and/or transfers in the log. First queuing device 110 may transmit the one or more identifiers from the log to the digital wallet service to transfer the suggested positional exchange amount.

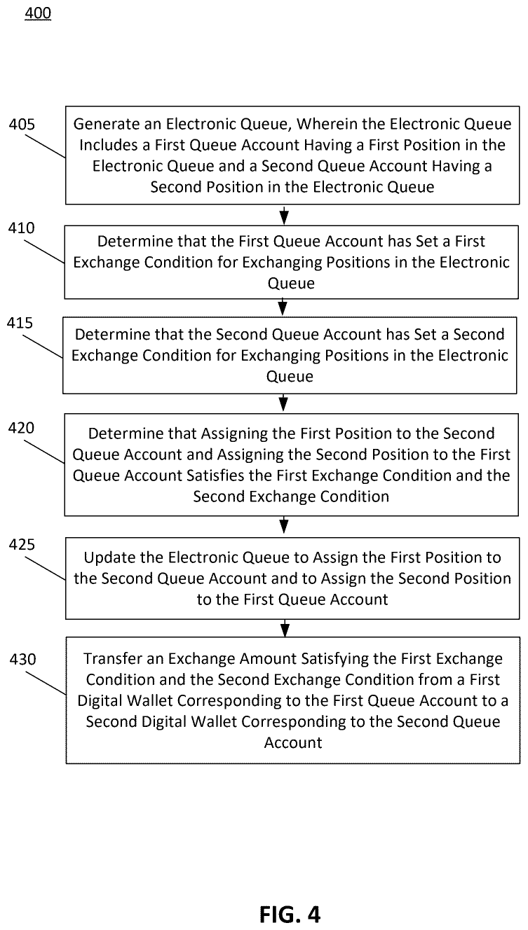

FIG. 4 depicts a flowchart illustrating a method 400 for illustrating method for queue management of an electronic queue, according to some embodiments. Method 400 shall be described with reference to FIG. 1B; however, method 400 is not limited to that example embodiment.

In an embodiment, queue management system 140 may utilize method 400 to manage an electronic queue and/or exchange positions between queue accounts in the electronic queue. For example, a first queue account may correspond to a first queuing device 110 and a second queue account may correspond to second queuing device 120. Users may use queuing devices 110, 120 to access respective queue accounts and/or to log in to queue management system 140 to join an electronic queue. For example, the electronic queue may correspond to ticket sale where the user enters a queue to purchase tickets on a queuing device 110, 120. Queue management system 140 may manage the queue and/or may communicate with and/or transmit commands to another system providing the queue. In addition to managing the electronic, queue management system 140 may facilitate the exchange of positions in the electronic queue for queue accounts. For example, a user corresponding to the first queue account may be willing to pay a monetary value to exchange their position in the ticket sale queue. The queue management system 140 may identify the second queue account, which may correspond to a user willing to yield their position in the electronic queue in exchange for the monetary value. Queue management system 140 may perform this exchange of positions for the queue accounts. The foregoing description will describe an embodiment of the method 400 with respect to queue management system 140. While method 400 is described with reference to queue management system 140, method 400 may be executed on any computing device, such as, for example, the computer system described with reference to FIG. 8 and/or processing logic that may comprise hardware (e.g., circuitry dedicated logic, programmable logic, microcode, etc.), software (e.g., instructions executing on a processing device), or combination thereof.

It is to be appreciated that not all steps may be needed to perform the disclosure provided herein. Further, some of the steps may be performed simultaneously, or in a different order than shown in FIG. 4, as will be understood by a person of ordinary skill in the art.

While the foregoing description describes an electronic queue, method 400 may also be applied to physical queuing systems and/or the tracking of physical queue positions. For example, queue management system 140 may maintain a data structure reflecting physical queue positions and/or manage the data structure in a manner similar to that described with reference to method 400.

At 405, queue management system 140 generates an electronic queue, wherein the electronic queue includes a first queue account having a first position in the electronic queue and a second queue account having a second position in the electronic queue. The first queue account may correspond to a first queuing device 110 while the second queue account may correspond to a second queuing device 120. Users may use first queuing device 110 and second queuing device 120 to join the electronic queue and/or view positions in the electronic queue. The electronic queue may be, for example, a queue to purchase tickets to an event. This may be an online ticketing system.

In some embodiments, queue management system 140 may form and/or may maintain positions in the queue. For example, queue accounts may provide login credentials to queue management system 140 to join the electronic queue. As user accounts reach the end of the queue and/or the lowest position in the queue, the user accounts may be permitted to purchase tickets. As will be further described below, queue management system 140 may also facilitate the exchange of positions in the electronic queue. In some embodiments, queue management system 140 may manage a queue for a separate service providing the ticketing and/or facilitate the exchange of queue positions for the other service.

At 410, queue management system 140 determines that the first queue account has set a first exchange condition for exchanging positions in the electronic queue. For example, this may be similar to 205 as described with reference to FIG. 2A. The first queue account may include a parameter indicating an amount that the user wishes to spend to exchange positions in the queue. The first queue account may include a limit or cap on funding to be used for exchanging queue positions. In some embodiments, the user corresponding to the first queue account may modify the user's preferences after joining the electronic queue. For example, after joining the electronic queue, the first queue account may be assigned position 1000. If the user wishes to have a position closer to the front of the queue, the user may modify the first queue account to set the first exchange condition to exchange positions. For example, the user may designate a dollar amount to spend to advance in the queue, the user may request a price for advancing a given number of positions, and/or queue management system 140 may provide a suggestion or recommendation for advancing in the queue. This may be based on the first exchange condition and/or other exchange conditions set by other queue accounts allowing others to exchange positions in the queue. For example, the queue accounts corresponding to position 999 and 998 may have specified an exchange condition for exchanging positions. The queue account in position 999 may request five cents to exchange positions while the queue account in position 998 may request eight cents to exchange positions. Similarly, a queue account in position 20 may request fifty dollars to exchange positions. In some embodiments, the exchange may be direct where the accounts in position 1000 and position 20 swap positions. In some embodiments, queue accounts may be moved in a manner that pushes other positions back.

At 415, queue management system 140 determines that the second queue account has set a second exchange condition for exchanging positions in the electronic queue. For example, this may be similar to 225 as described with reference to FIG. 2B. This may correspond to an acceptable amount of funding to exchange queue positions. For example, for a second queue account in position 20 to swap positions with a first queue account in position 1000, the second queue account may specify an exchange condition of fifty dollars. Queue management system 140 may receive this designation from the second queue account and/or calculate the exchange based on preferences specified by the queue accounts. For example, the exchange condition for the second queue account to move to position 85 may be less than the exchange condition to move to position 1000.

At 420, queue management system 140 determines that assigning the first position to the second queue account and assigning the second position to the first queue account satisfies the first exchange condition and the second exchange condition. For example, the first queue account may have position 1000 while the second queue account may have position 998. The first and second exchange conditions may specify a transfer of eight cents from the first queue account to the second queue account to exchange positions. Queue management system 140 may determine that this amount overlaps with the conditions set by the queue accounts. Queue management system 140 may the transmit a graphical user interface prompt to queuing devices corresponding to the first queue account and/or the second queue account with a request to exchange queue positions. The graphical user interface prompt may include the determined exchange amount. In response, queue management system 140 may receive an acceptance message from the queuing devices indicating acceptance of the exchange amount for exchanging positions. Upon receiving an acceptance, queue management system 140 may re-assign the positions in the electronic queue. In some embodiments, queue management system 140 may automatically re-assign the positions based on previously defined account preferences indicating a pre-authorization to exchange amounts for queue positions.

Queue management system 140 may manage a plurality of exchange conditions by a plurality of queue accounts. Queue management system 140 may use such information to identify overlapping exchange conditions to facilitate queue position exchanges between queue accounts.

At 425, queue management system 140 updates the electronic queue to assign the first position to the second queue account and to assign the second position to the first queue account. For example, queue management system 140 may modify the data structure of the electronic queue to exchange the positions. Queue management system 140 may also transmit a notification to first queuing device 110 and/or second queuing device 120 to inform users that the exchange of positions has occurred. This may include indicating the newly assigned position. In some embodiments, when the queue is provided by a service separate from queue management system 140, queue management system 140 may transmit a command to the separate queue service system instructing the service system to exchange the positions. This command may be a message and/or data packet including identifiers for the first and second queue accounts and/or the newly assigned positions.

At 430, queue management system 140 may transfer an exchange amount satisfying the first exchange condition and the second exchange condition from a first digital wallet corresponding to the first queue account to a second digital wallet corresponding to the second queue account. This may occur in a manner similar to 220 as described with reference to FIG. 2A. For example, queue management system 140 may use a digital wallet service and/or identifiers corresponding to the first and second digital wallets to transfer the exchange amount. As previously described, the exchange amount may be determined based on the first and second exchange conditions set by the first and second queue accounts. Users may have also provided an acceptance of the exchange amount to exchange the positions and to facilitate the transfer.

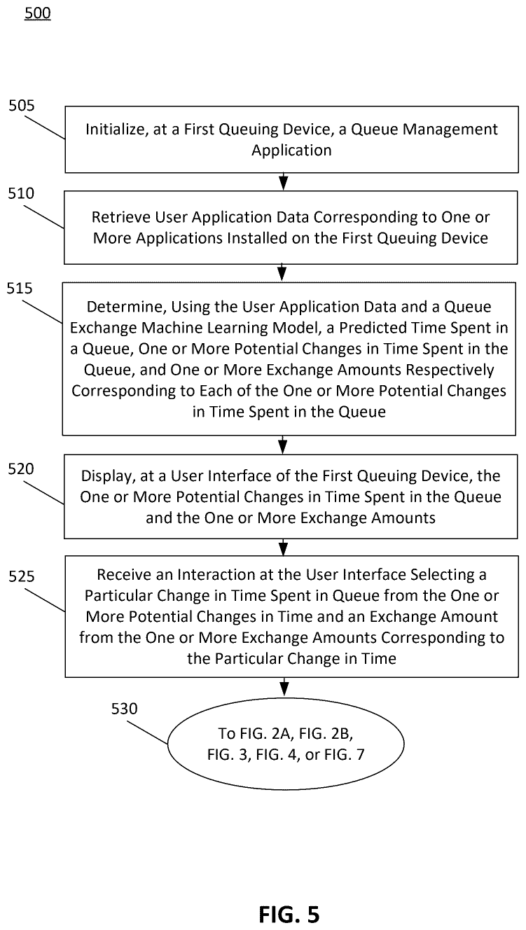

FIG. 5 depicts a flowchart illustrating method 500 for determining user preferences for exchanging positions with other queuing devices in a queue. Method 500 shall be described with reference to FIGS. 1A-3; however, method 500 is not limited to that example embodiment.

In an embodiment, first queuing device 110 may utilize method 500 to retrieve user application data, which may be used to inform and/or calculate options for changing the amount of time a user spends in a queue. The application data may include user inputs and/or interactions with applications installed on the first queuing device 110. This application data may also include user preferences regarding time spent in queues and/or expenditure preferences, such as an exchange amount, a total cost, and/or other amount associated with changing the time spent in the queue. The user preference may be used to determine a preferred total time spent in the queue and/or an exchange amount for exchanging queue positions with one or more other queuing devices. The amounts exchanged may depend on the amount of time that a user has indicated they would like to save. For example, to save five minutes a corresponding amount of five dollars may be distributed to the one or more queuing devices that yield their positions in the queue. Similarly, a user who is not in a rush may indicate that he or she is willing to receive a transaction amount and/or monetary value for yielding his or her position in the queue. The user of first queuing device 110 may indicate a preference and/or a selection of an amount of time he or she would like to spend in the queue. This may include a reduction in time and/or an increase in time. While the foregoing description may describe reductions in the amount of time in a queue, such descriptions are also applicable to increasing the amount of time spend in a queue and/or a user setting that they would like to receive funding for yielding a queue position.

In some embodiments, the queue may be a physical queue and first queuing device 110 may be in a vehicle on a road or highway and trade relative geographical positions along a road or highway with one or more other queuing devices, such as second queuing device 120. First queuing device 110 may exchange physical positions with multiple queuing devices, where each exchange of position contributes to changing the amount of time spent in the queue and/or an exchange amount to achieve the change in the amount of time. Additionally, first queuing device 110 may be associated with a queue system account on a computing device belonging to an electronic queue. Similar to the previous example, user preferences regarding time spent in the queue and exchange amount are used to determine one or more exchanges with a second queuing device or multiple other queuing devices. Each exchange in position in the queue may contribute to a portion of the change in time spent in the queue and/or total exchange amount to achieve the preferred queue time. The exchange in queue position may occur in a manner similar to the process described in FIGS. 2A-4. This may apply to physical queues and/or electronic queues.

The foregoing description will describe an embodiment of the method 500 with respect to first queuing device 110. While method 500 is described with reference to first queuing device 110, method 500 may be executed on any computing device, such as, for example, the computer system described with reference to FIG. 8 and/or processing logic that may comprise hardware (e.g., circuitry dedicated logic, programmable logic, microcode, etc.), software (e.g., instructions executing on a processing device), or combination thereof.

It is to be appreciated that not all steps may be needed to perform the disclosure provided herein. Further, some of the steps may be performed simultaneously, or in a different order than shown in FIG. 8, as will be understood by a person of ordinary skill in the art.

At 505, first queuing device 110 initializes a queue management application. This may be similar to 305 as described with reference to FIG. 3. For example, when first queuing device 110 corresponds to a vehicle, the initialization may correspond to powering on the vehicle and/or accessing a queue management application on a computing device of the vehicle. In some embodiments, the queue management application may be installed on a mobile device. The initialization may include a user accessing the application on the mobile device.

As a part of the initialization process, first queuing device 110 may receive queue system account information from queue management system 140. The user of the first queuing device 110 may have previously registered with the queue management system 140. If the user of the first queuing device 110 has previously registered, the queue system account information may include user preferences, payment information associated with a digital wallet service, and/or identifying information of the first queuing device 110. If the user of the first queuing device 110 has not previously registered, there may be less queue system account information available from queue management system 140. In some embodiments, the user may perform a registration with queue management system 140 using first queuing device 110.

At 510, first queuing device 110 retrieves user application data corresponding to one or more applications installed on first queuing device 110. The user application data may be retrieved by pulling data from applications on the first user device 110, such as calendar data, traffic data, location data, and/or other application data. The user application data may be retrieved from a calendar application and/or a trip planning application. For example, first queuing device 110 may retrieve the application data from memory. Depending on the type of queue, data may be pulled from one or more applications. First queuing device 110 and/or queue management system 140 may use the application data to determine the queue the first queuing device 110 is entering. For example, this may be a particular route on a roadway and/or a particular line where the user is standing. Using this application, first queuing device 110 and/or queue management system 140 may determine a predicted time spent in queue, an offer to change the amount of time spent in the queue, and/or an exchange amount for achieving the specific length of time spent in the queue. The change in time and/or the respective exchange amount is further described with reference to 515 below.

In some embodiments, the application data may include application retrieved from applications external to first queuing device 110. For example, this may include data gathered from other queuing devices that may provide a predicted amount of time spent in a queue. During initialization, first queuing device 110 may be associated with a registered queue system account. The data from the other queuing devices and/or from previous instances of the first queuing device 110 and/or other queuing devices being in the same or similar queues may also be retrieved. This data may then be used to provide the predicted time spent in the queue, one or more potential changes in time spent in the queue, and/or the exchange amounts described with reference to 515.

In some embodiments, the application data may include user inputs and/or selections. For example, a user may pre-configure a calendar application to minimize the amount of time spent in traffic on a particular day and/or a series of days. Retrieving the user application data may include retrieving calendar data to identify one or more potential changes in time based on this set preference. Similarly, GPS data and/or trip planning application data may be retrieved to determine one or more potential changes in time spent in a queue. For example, a user may enter a destination address and/or starting address into a trip planning and/or map application.

As will be further described with reference to 515, one or more potential changes in time spent in a queue and/or one or more exchange amounts respectively corresponding to each of the one or more potential changes in time may be determined at first queuing device 110. In some embodiments, queue management system 140 may determine the changes in time and/or the corresponding exchange amounts. Queue management system 140 may determine these parameters using the user application data. Queue management system 140 may receive the data from the first queuing device 110, retrieve the application data from internal memory, receive application data from one or more other queuing devices 120, and/or from an external system.

In some embodiments, data may be retrieved by first queuing device 110, queue management system 140, a backend service and/or computer system 800, as described in FIG. 800. The specific computing device retrieving the user application data may depend on the processor of first queuing device 110, network 130 availability, and/or the availability of server applications. Additionally, data may be retrieved automatically upon initialization of the queue management application, without further input. In some embodiments, the retrieval of user application data by initialized via a user input allowing access to applications and/or instruction to gather application data.

In some embodiments, first queuing device 110 and/or the other queuing devices may be communication devices capable of being held by a user in a physical line. For example, such lines may include a ticket line, ride line, checkout line, and/or similar physical queuing lines where users may trade positions in the physical line. The user application data may include data from an application specific to the queue. For example, in a queue representing a ride line, the amusement, adventure, theme, or similar type park may have an application indicating existing ride lines or wait times within the park. This data may be retrieved and/or used at 515. The user application data may also include detailed location data within the park that may be retrieved.

In some embodiments, the queue may be an electronic queue. The electronic queue may be facilitated by queue management system 140 and/or another system. Queuc management system 140 may receive data from the facilitating system. The data may include information such as queue system account positions associated with the position of the queuing devices in the queue, queue time estimates, a number of queue system accounts, identifiers of accounts, identifiers of associated queuing devices in the queue, and/or other data specific to the electronic queue.

In some embodiments, the user may provide a preferred exchange amount, which may be used in 515 to determine a threshold for exchange amounts. The preferred exchange amount may be a guide for determining whether the desired reduction in time is feasible for the desired amount. The additional gathered data may indicate that first queuing device 110 cannot reduce the time spent in the queue for the desired exchange amount. In this case, first queuing device 110 may exit the queue management application.

At 515, first queuing device 110 determines, using the user application data and a queue exchange machine learning model, a predicted time spent in a queue, one or more potential changes in time spent in the queue, and one or more exchange amounts respectively corresponding to each of the one or more potential changes in time spent in the queue. The predicted time spent in the queue may be, for example, an amount of time to reach a particular destination address, an estimated amount of delay due to traffic, an amount of time to reach the front or end of a queue, and/or other time measurement. In some embodiments, the time spent in queue may also correspond to a position and/or position number in the queue.

The one or more potential changes in time spent in the queue may correspond to offers to decrease or increase the amount of time spent in the queue. For example, if a user wishes to spend less time in the queue, potential changes in time may be reflected as a reduction of 5 minutes, a reduction of 10 minutes, and/or other timing options to reduce queue time and/or position. As further explained below, these potential changes in time may present options. A user may select one of these options to set a goal of reducing the amount of time in the queue. A user may also change this selection as well. In some embodiments, a user may have available time and may yield queue position in exchange for a transaction amount or a microtransaction. In this case, the potential changes in time may be reflected as increases to the time spent in the queue. Users may select between increasing or decreasing the amount of time they wish to spend in the queue. The queue exchange machine learning model determines available options and/or corresponding exchange amounts. In some embodiments, the time spent in queue may be limited by physical restraints. For example, if a trip with no traffic takes one hour to complete, the potential changes in time may not include options that would reduce this timing to under this one hour limit.

The one or more exchange amounts respectively corresponding to each of the one or more potential changes in time spent in the queue may be determined based on settings from other queuing devices in the queue. For example, these values may depend on whether queuing devices are willing to yield positions and/or preferences set by those queuing devices for yielding their respective positions. The queue exchange machine learning model, which may be implemented on first queuing device 110 and/or queue management system 140 may provide values for the predicted time spent in the queue, one or more potential changes in time, and/or one or more exchange amounts respectively corresponding to those potential changes in time.

To illustrate an example, the queue exchange machine learning model may be trained to determine an exchange amount for the queue corresponding to the change in time spent in the queue. For example, if the predicted time in the queue is 1 hour, the queue exchange machine learning model may produce a range of values that reduce the time spent in the queue. For example, this may be a reduction by 2 minutes, by 5 minutes, or by 10 minutes and/or may be a non-discrete range that may be used to specify a reduction in time. As the amount of time spent in queue is reduced, the queue exchange machine learning model may increase the exchange amount used to exchanging positions to achieve that reduction in time. If the user is willing to spend more time in the queue, there may be a decrease in the exchange amount and/or an indication that an exchange amount will be received.

In some embodiments, an increase in the exchange amount may indicate that first queuing device 110 will provide compensation to other queuing devices to exchange positions and decrease time spent in the queue for first queuing device 110. A decrease in the exchange amount may indicate first queuing device 110 will receive compensation from other queuing devices for exchanging positions in the queue and increasing time spent in the queue while decreasing time spent in the queue for other queuing devices. For example, the compensation may include a monetary payment, such as fiat currency or cryptocurrency. In some embodiments, the compensation may be a microtransaction.

For example, if first queuing device 110 is located in a vehicle, retrieved calendar data may indicate the user of first queuing device 110 has a meeting scheduled at 9:00 every Monday morning in the same location. Retrieved location and traffic data, such as from GPS applications, may provide a route to the location of the meeting. Therefore, first queuing device 110 will join a queue representing the route to the location of the meeting and intends to arrive by 9:00. In some embodiments, the first queuing device 110 may join multiple queues to reach the destination location. In addition, data stored in account database 150 and/or other user application data may indicate that first queuing device 110 has previously arrived at approximately 8:45 based on route traversal or queue completion. In some embodiments, this user application data is retrieved as soon as the application is initialized and without any user knowledge or interaction beyond initialization. In some embodiments, there may be a required interaction with prompts at user interface 112 of queuing device 110 in order to retrieve the data or determine the correct queue for first queuing device 110. Based on the retrieved user application data, a queue exchange machine learning model may determine a predicted time spent in the queue based on the current location, route, and traffic patterns along the route. The queue exchange machine learning model may also be trained to recognize first queuing device 110 behavior in the queue, such a speed and/or a rate of travel, and/or the queue system account for the data associated with the behavior when predicting time spent in queue. Additionally, the queue exchange machine learning model may be trained to examine the user application data retrieved and stored queue system account data to determine a range of values corresponding to one or more potential changes in time that first queuing device 110 may spend in the queue relative to the predicted time value. First queuing device 110 may decrease or increase the time spent in the queue based on a selection of a particular potential change in time as further described at 525. The queue exchange machine learning model may provide a corresponding respective exchange amount for each value of the potential change in time spent in the queue.

For example, a predicted time spent in queue may indicate that first queuing device 110 may reach a destination at 8:50. Based on this predicted time, the queue exchange learning model may produce a range of potential changes in time for first queuing device 110 to arrive at the location of the meeting. For example, a range may be presented from 8:30 to 9:15. The times closer to 8:30 may correspond to an increase in exchange amount while times closer to 9:15 may decrease the exchange amount, such that first queuing device 110 is receiving compensation. For example, to reach the destination at 8:30, the corresponding exchange amount may be twenty dollars. To reach the destination at 8:40, the corresponding exchange amount may be ten dollars. To spend more time in the queue and arrive at 9:15, the exchange amount may be a negative fifteen dollars. This negative amount may correspond to the receipt of an exchange amount rather than a payment of the exchange amount.

In some embodiments, a range may also indicate that no exchange amount is offered. For example, a range from 8:40 to 8:55 may represent first queuing device 110 not exchanging positions with another queuing device and a null exchange amount. In some embodiments, the change in time spent in the queue and the respective exchange amounts may not be proportional on either side of the predicted time spent. The respective exchange amounts may depend on the user application data retrieved and/or queue system management data.

In some embodiments, the queue exchange machine learning model may also determine a likelihood that the user will achieve the desired change in time spent in queue for the exchange amount. For example, different potential changes in time spent in the queue and/or the respective exchange amounts may have varying likelihoods of success. For example, when the predicted time spent in queue corresponds to arriving at 8:45, the potential change in arrival time to 8:30 for the respective exchange amount may have a greater likelihood of success than a potential change in arrival time to 8:20. The queue exchange machine learning model may be trained to determine a likelihood of success based on user application data and/or queue data from one or more queuing devices participating in the queue and/or data stored in account database 150.

In some embodiments, such as a physical queue, time may be a factor in user application data and/or user preferences for the queue. In an electronic queue, the numerical position of first queuing device 110 relative to other queuing device may be considered. For example, an exchange in position in queue may be used rather than a time difference. Method 500 and 515 may be applied to positional exchanges and/or predictions as well. For example, and as described in FIG. 4, first queuing device 110 may correspond to position 999 but desire a higher position, such as 800, or a lower position, such as 1000. The change in time spent in the queue may account for time. For example, the change in time spent in the queue may also correspond to a change in position. The queue machine learning model may be trained to determine one or more changes in position in the queue and/or corresponding exchange amounts. The queue exchange machine learning model may provide a predicted position in queue, which may be the position of the queue system account corresponding to a first queuing device 110 position. The queue exchange machine learning model may also determine one or more potential changes in position and respective exchange amounts for each potential change in position. For example, the queue exchange machine learning model may determine a range of potential changes in position from 800 to 1000 for a predicted position in the queue of 999. These changes in position may have respective exchange amounts.

At 520, first queuing device 110 displays, at user interface 112, the one or more potential changes in time spent in the queue and the one or more exchange amounts. These changes in time and exchanges amounts may have been determined by the queue exchange machine learning model. As previously explained, the queue exchange machine learning model may reside on first queuing device 110 and/or on queue management system 140. When residing on queue management system 140, first queuing device 110 may receive the one or more potential changes in time and the one or more exchange amounts via network 130.

User interface 112 may display the predicted time spent in the queue, the one or more potential changes in the time spent in the queue, and/or the one or more respective exchange amounts corresponding to each of the potential changes in time spent in the queue. In some embodiments, user interface 112 may also display a likelihood of success for each potential change in time spent in the queue and respective exchange amount. User interface 112 may display the information using a graphical user interface (GUI). For example, the GUI may include a dial or spectrum to display the range of one or more potential changes in time. For example, a lower limit of the change in time range and respective exchange amount may be displayed on the left side of the dial. The upper limit of the change in time range and respective exchange amount may be displayed on the right side of the dial.

User interface 112 may also display an option for the user to manually input additional data and/or modify existing user preferences. For example, a user may select a different destination address, wish to travel a different route, and/or change queues. The user may also modify other user application data. In response to such modifications, the queue exchange machine learning model may perform additional interactions to determine updated changes in time spent in the queue and respective exchange amount. Additionally, the user may provide feedback to re-train the queue exchange machine learning model. For example, such feedback may include user indications that first queuing device 110 may spend a greater range in time spent in the queue, the respective exchange amount is too far outside a threshold, and/or the threshold for the exchange amount is higher than initially determined. This feedback may be provided via user interface 112.

At 525, first queuing device 110 receives an interaction via user interface 112 that selects a particular change in time spent in the queue from the one or more potential changes in time and an exchange amount from the one or more exchange amounts corresponding to the particular change in time. In user may interact with a GUI display on user interface 112 to provide the selection. This may include selecting an icon accepting a proposed change in time, selecting an icon accepting a proposed exchange amount, entering a numeric value into the GUI, using a dial GUI object to select a value, and/or other interactions with GUI objects to provide a selection. This may include gestures interfacing with a touchscreen display and/or using physical buttons. For providing a selection via a GUI dial and/or a physical dial, a user may perform a gesture to turn the dial, the various potential changes in time in queue and respective exchange amounts may be displayed in response to turning the dial, and a selection may be made. For example, a user may press a GUI button or physical button to confirm the selection. In some embodiments, the interaction may not be from the user but a computing device managing the first queuing device 110, such as in a self-driving car or mobile computing device. The computing system of the vehicle may autonomously select the potential change in time in queue and respective exchange amount without further input from the user. For example, this may be based on one or more pre-configured rules and/or may be based on user application data. For example, a user may have a pre-set rule to automatically reduce the amount of spent in traffic during a morning commute but to spend no more than ten dollars each morning. An automatic selection may be made based on such a rule.

At 530, once a selection of a particular change in time and a corresponding exchange amount is made, first queuing device 110 proceeds to aspects of method 200A, 200B, 300, 400, or 700, as described in FIGS. 2A, 2B, 3, 4, and 7. Based on the selected particular change in time and/or the respective exchange amount, first queuing device 110 may exchange positions with one or more queuing devices. The exchange in positions, transfer of exchange amount, and/or transfers of portions of the exchange amount may be performed in accordance with methods 200A, 200B, 300, 400, and/or 700. Each exchange in position with a particular queuing device, such as second queuing device 120, may contribute to a portion of the change in time spent in the queue and/or the exchange amount selected. For example, each individual exchange in position may represent an iteration of methods 200A, 200B and/or potions of methods 300, 400, and/or 700.

In some embodiments, once a selection is made, first queuing device 110 proceeds through method 300 or 400, as described in FIGS. 3 and 4. First queuing device 110 may exchange positions with one or more queuing devices in accordance with these methods. Each exchange in position with another queuing device, performed in accordance with methods 300 or 400, may move the predicted time spent in the queue closer to the selected change in time spent in queue. Additionally, each exchange amount corresponding to the exchange in position with another queuing device may be a portion of the selected exchange amount.

For example, in a physical queue where first queuing device 110 is a computing device located in a vehicle, the predicted time spent in the queue may be 1 hour with an arrival time at 9:00 AM. The one or more potential change in time spent in the queue may range from a 15 minute decrease in time spent in the queue to arrive at 8:45 AM at a $20 exchange amount to a 15 minute increase in time spent in the queue to arrive at 9:15 AM at a −$10 exchange amount. The negative exchange amount indicates first queuing device 110 is being compensated for increasing the change in time spent in the queue. If the selected change in time is the 15 minute decrease in time spent in the queue to arrive at 8:45 AM at a $20 exchange amount, first queuing device 110 may use method 300 to exchange positions with one or more queuing devices. For example, first queuing device 110 may exchange positions three times with three different queuing devices in the queue. The first exchange in position may decrease the time spent in the queue by 10 minutes, the second exchange in position may decrease the time spent in the queue by 3 minutes, and the third may decrease the time spent in the queue by 2 minutes. Each exchange in position may have a portion of the selected exchange amount transferred from first queuing device 110 to second queuing device 120, in accordance with methods 300 and 400. Each exchange amount may vary based on the exchange conditions of first queuing device 110 and second queuing device 120 as described in methods 300, and further described in methods 200A and 200B. The combined portions of the exchange amount may amount to the selected exchange amount. In some embodiments, first queuing device 110 may confirm that the combined portions do not exceed the selected exchange amount. In some embodiments and similar to the example above, first queuing device 110 may be communication devices capable of being held by a user in a physical line, where users may be exchanging position to increase or decrease the wait time in the line.

In some embodiments, the queue is an electronic queue and the change in time spent in the queue may be a change in position in the queue. As similarly described above, the selected change in position may be a target position the user of first queuing device 110 would like to achieve from a current position in the queue. First queuing device 110 may exchange positions in the queue with multiple queuing devices to achieve the selected change in position. For example, if the current position of first queuing device 110 is 900, and the selected change in position is 300 to move to position 600, first queuing device 110 may exchange positions with the queuing device at position 600 to achieve this position. In some embodiments, multiple exchanges may occur. For example, first queuing device 110 may exchange positions with queuing devices having positions 850, 700, and 600 to achieve the selected position, as described in method 400. Additionally and as described above, each exchange amount may vary based on the exchange conditions of first queuing device 110 and second queuing device 120 as described in method 400. The combined exchange amounts may each represent a portion of the selected exchange amount. When combined, the portions of the selected exchange amount may not exceed the selected exchange amount.

For convenience of explanation, three exchanges in position were described in the examples. The total number of exchanges in position, however, is not limited in this manner. For example, the number of exchanges may range from 1 to exchanges in the hundreds or thousands, depending on what is appropriate for the queue. Additionally, the use of microtransactions may facilitate the transaction of a large number of exchanges in position for a reasonable exchange amount, as described with reference to 525.

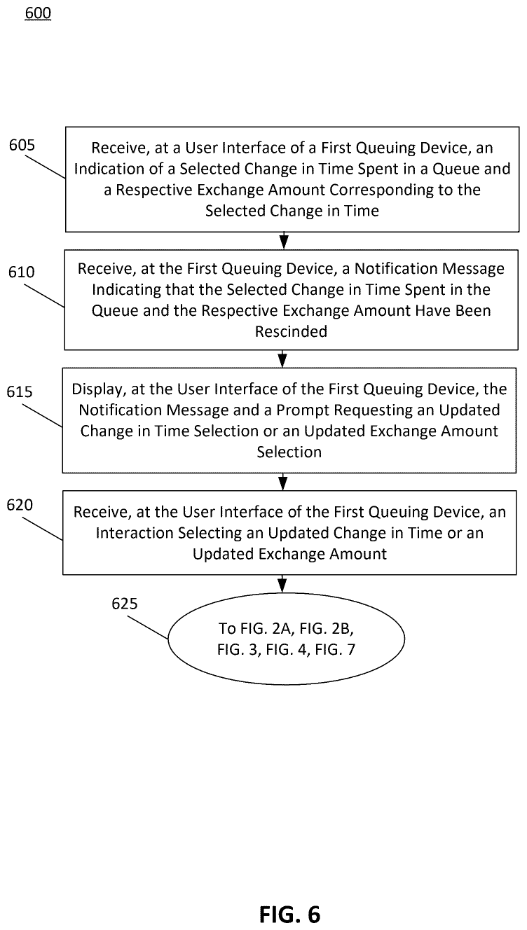

FIG. 6 depicts a flowchart illustrating method 600 for providing a notification to request an updated exchange amount. Method 600 shall be described with reference to FIG. 1A and FIG. 5; however, method 600 is not limited to that example embodiment.

In an embodiment, first queuing device 110 may be in a queue and may be exchanging positions in the queue with one or more other queuing devices, such as second queuing device 120. Portions of the selected exchange amount from method 500 may be used to exchange positions with the one or more other queuing devices. These portions may amount to the selected exchange amount to achieve the selected change in time spent in the queue. In some scenarios, however, the selected exchange amount may no longer correspond to the selected change in time and/or the selected change in time may not be possible to achieve. For example, if a sudden car accident occurs on a roadway, this may render the previously selected change in time and corresponding exchange amount invalid. First queuing device 110 and/or queue management system 140 may detect this issue. For example, queue management system 140 may notify first queuing device 110 that the selected change in time and/or the respective exchange amount has been rescinded. Queue management system 140 may identify one or more alternatives and/or may request an updated exchange amount and/or an updated change in time or position in the queue from the first queuing device 110.

The foregoing description will describe an embodiment of the method 600 with respect to first queuing device 110. While method 600 is described with reference to first queuing device 110, method 600 may be executed on any computing device, such as, for example, the computer system described with reference to FIG. 8 and/or processing logic that may comprise hardware (e.g., circuitry dedicated logic, programmable logic, microcode, etc.), software (e.g., instructions executing on a processing device), or combination thereof.

It is to be appreciated that not all steps may be needed to perform the disclosure provided herein. Further, some of the steps may be performed simultaneously, or in a different order than shown in FIG. 6, as will be understood by a person of ordinary skill in the art.

At 605, first queuing device 110 receives, at user interface 112, an indication of a selected change in time spent in a queue and a respective exchange amount corresponding to the selected change in time. In some embodiments, this selection may the selection received at 525 as described with reference to FIG. 5. For example, first queuing device 110 may receive a selection based on method 500. In some embodiments, 605 may include aspects from methods 200A, 200B, 300, 400, and/or 700. For example, a user may join a queue, participate in a queue, and/or traverse a queue at 605. Method 600 may account for a modification to the change in time spent in the queue and/or the exchange amount. This may occur due to a change in queue status. For example, an automobile accident and/or an unpredicted increase in traffic may invalidate the selected change in time and/or exchange amount. This may also occur if first queuing device 110 becomes unable to perform one or more exchanges in position in the queue.

At 610, first queuing device 110 receives a notification message indicating that the selected change in time spent in the queue and the respective exchange amount have been rescinded. For example, the selected change in time spent in the queue and respective exchange amount may no longer be valid to achieve the desired change in time. First queuing device 110 and/or queue management system 140 may determine that the selected change in time is not valid and/or may rescind the original selection. First queuing device 110 and/or queue management system 140 may determine one or more updated changes in time and/or corresponding updated exchange amounts. For example, the queue exchange machine learning model may generate an updated predicted time spent in queue. Similarly, the queue exchange machine learning model may generate updated potential changes in time and/or updated respective exchange amounts. User interface 112 may present these options to the user and/or request an updated change in time and/or exchange amount.

In some embodiments, the change in time may be a change in position and/or a combination of time and position. The queue exchange machine learning model may continuously update the potential changes in time and respective exchange amounts in the background. If the selected change in time and exchange amount become no longer possible and/or deviate from the selection, queue management system 140 may send the notification message to first queuing device 110. For example, when first queuing device 110 is a computing device in a vehicle, there may be an automobile accident or car wreck that may delay queuing devices in the queue. The change in time spent in the queue for first queuing device 110 may therefore be impacted. For example, to achieve the desired change in time, there may be an increase in exchange amount. In some instances, the impact may render the selected change in time no longer be possible. In some embodiments, updated user application data may change the selected time. For example, calendar data may indicate a meeting has been canceled and first queuing device 110 may no longer expect the same arrival time. In this instance, first queuing device 110 may update the change in time and/or exchange amount. This may indicate an increase to the predicted time in queue and/or a willingness to receive payment to exchange positions.

In some embodiments, the queuing devices may be communication devices capable of being held by a user in a physical line, such as ticket line, ride line, checkout line, and/or similar physical queuing lines where users may trade positions in the physical line. For example, in a ride line, queue management system 140 may retrieve data that the ride is shut down, increasing the wait times for the ride. This may result in a deviation, invalidation, and/or a rescinding of the selected change in time spent in the queue for the user or make the desired time unachievable. Similar to the previous example, the user may want to update the change in time spent in the queue and/or respective exchange amount, keep the selected change in time spent in the queue and/or respective exchange amount from 525, or leave the queue.

In some embodiments, the queue may be an electronic queue. The system facilitating the electronic queue may experience maintenance and/or cause an increased change in queue position for first queuing device 110. In some embodiments, an increased change in queue position may become more desirable. In some embodiments, the exchange amount may have been reached before the change in time spent in queue is achieved. Queue management system 140 may send the notification and/or request an increase in the exchange amount.

At 615, first queuing device 110 displays, at user interface 112, the notification message and a prompt requesting an updated change in time selection or an updated exchange amount selection. The prompt may include one or more suggested updated changes in time and exchange amounts based on the queue exchange machine learning model. User interface 112 may display the notification messaging indicating the previously selected change in time spent in the queue and/or the previous exchange amount are no longer valid to achieve the desired change in time. This invalidation may correspond to queue management system 140 rescinding the selection as options. The prompt may request an updated change in time and/or exchange amount. This may include options calculated by queue management system 140 and/or may include updated one or more potential changes in time spent in the queue and respective exchange amounts, similar to 515. The updated amounts may considering the additional and/or modified application data. This may include calendar data, trip planning data, location data, data provided by other queuing devices, and/or other queue data. The updated one or more potential changes in time spent in the queue and respective exchange amounts may also be displayed using a dial, spectrum, and/or visual GUI indication of the range. This may be similar to the display described with reference to 520.

At 620, first queuing device 110 receives, via user interface 112, an interaction selecting an updated change in time or an updated exchange amount. This may be a selection from one or more options determined by first queuing device 110 and/or queue management system 140. The one or more options may be displayed, cycled through, and/or selected using user interface 112. For example, a user may perform a gesture to turn a GUI dial or a physical dial. In response to turning the dial, various potential changes in time in queue and respective exchange amounts may be displayed. The user may then perform a selection using the dial and/or one or more buttons on user interface 112. In some embodiments, the user may be provided with an indication that to maintain the same desired change in queue time, the exchange amount will be increased. The user may accept and/or confirm this increase. Similarly, in some embodiments, the prompt may indicate that a particular amount of time is no longer available and that spending the same exchange amount may result in a different change in queue time occurring. The user may also confirm this selection. In some embodiments, a user may reject the change and/or provide a selection indicating that he or she does not wish to continue participation in reducing time spend in the queue.

In some embodiments, the interaction at 620 may be similar to 525 as described with reference to FIG. 5. Similar to 525, in some embodiments, the interaction may not be from the user, but may be a selection from a computing device managing the first queuing device 110. This may include a self-driving car and/or a mobile computing device. The computing system of the vehicle may autonomously select the potential change in time in queue and respective exchange amount without further input from the user. This may be based on a preset configuration and/or preprogramming as previously described.

At 625, once a selection of a particular change in time and a corresponding exchange amount is made, first queuing device 110 proceeds to aspects of method 200A, 200B, 300, 400, or 700, as described in FIGS. 2A, 2B, 3, 4, and 7. This may occur in a manner similar to 530 as described with reference to FIG. 5. For example, using the updated change in time and/or updated exchange amount, first queuing device 110 may continue exchanging positions with one or more queuing devices. The exchange in positions, transfer of the updated exchange amount, and/or transfers of portions of the updated exchange amount may be performed in accordance with methods 200A, 200B, 300, 400, and/or 700. Each exchange in position with a particular queuing device, such as second queuing device 120, may contribute to a portion of the updated change in time spent in the queue and/or the updated exchange amount selected. For example, each individual exchange in position may represent an iteration of methods 200A, 200B and/or potions of methods 300, 400, and/or 700. In this manner, first queuing device 110 may continue to exchange position in the queue in accordance with the updated change in time spent in the queue and respective updated exchange amount.

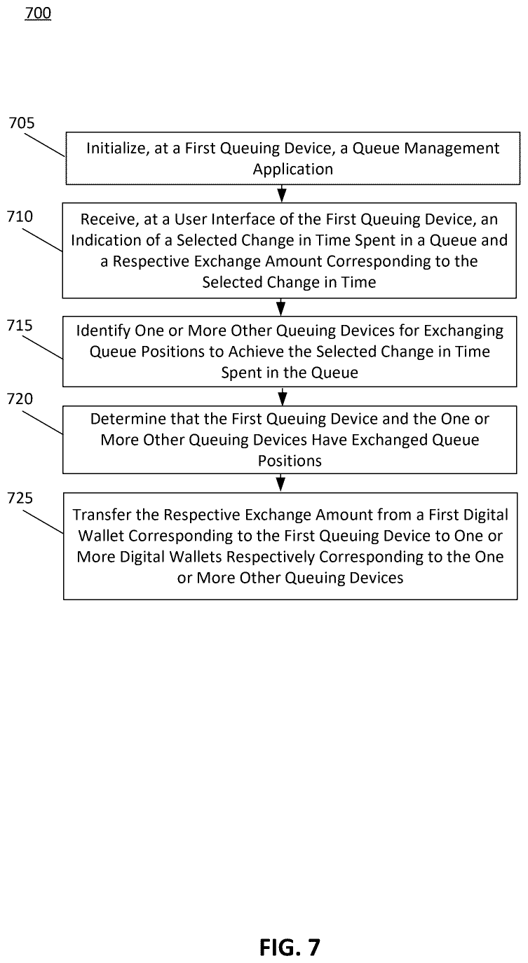

FIG. 7 depicts a flowchart illustrating a method 700 for facilitating an exchange of positions with one or more queuing devices based on a selected change in time spent in a queue, according to some embodiments. Method 700 shall be described with reference to FIGS. 1A, 1B, and 2-6; however, method 700 is not limited to those example embodiments.

In an embodiment, first queuing device 110 may utilize method 700 to exchange positions in a queue with one or more queuing devices, such as second queuing device 120. For example, the queuing devices may be located in vehicles and trade relative geographical positions along a road or highway. In some embodiments, first queuing device 110 and second queuing device 120 may correspond to users standing in a queue. For example, such a queue may be at a theme park, at an event venue, at a grocery store, and/or other scenarios where uses may form a queue. First queuing device 110 and second queuing device 120 may trade positions in the queue when the users operating the first and second queuing devices 110, 120 exchange physical locations. The queue may be an electronic queue where positions in the electronic queue may be exchanged.

The foregoing description will describe an embodiment of the method 700 with respect to the first queuing device 110. While method 700 is described with reference to first queuing device 110, method 700 may be executed on any computing device, such as, for example, second queuing device 120, or the computer system described with reference to FIG. 8 and/or processing logic that may comprise hardware (e.g., circuitry dedicated logic, programmable logic, microcode, etc.), software (e.g., instructions executing on a processing device), or combination thereof.

It is to be appreciated that not all steps may be needed to perform the disclosure provided herein. Further, some of the steps may be performed simultaneously, or in a different order than shown in FIG. 7, as will be understood by a person of ordinary skill in the art.

In some embodiments, FIG. 7 may implement aspects of methods 200A, 200B, 300, 400, 500, and 600. Method 700 may be used to determine, for first queuing device 110, a change in time spent in the queue from a predicted time spent in the queue and a respective exchange amount to exchange positions with one or more queuing devices for portions of the respective exchange amount.

As described with reference to FIG. 5 and FIG. 6, in some embodiments, queue management system 140 may determine a predicted time spent in the queue and/or one or more potential changes in time spent in queue. Queue management system 140 may also determine respective exchange amounts. First queuing device 110 may select the desired change in time and/or exchange amount through interaction with user interface 112. This may occur in the manner described with reference to methods 500 and/or 600. Subsequently, in accordance with methods 200A, 200B, 300, or 400, first queuing device 110 may perform one or more transactions for a portion of the exchange amount to change positions in the queue in order to achieve the selected change in time spent in the queue. This may apply to physical queues and/or electronic queues.

At 705, first queuing device 110 initializes a queue management application. This may occur in a manner similar to 305 as described with reference to FIGS. 3 and/or 505 as described with reference to FIG. 5. First queuing device 110 may also execute 310, 315, 320, and 325 as described with reference to FIGS. 3 and/or 510, 515, and/or 520 as described with reference to FIG. 5. For example, first queuing device 110 and/or queue management system 140 may utilize the queue exchange machine learning model to determine a predicted time spent in the queue, one or more potential values for the change in time spent in queue, and/or respective exchange amounts. In some embodiments, the queue exchange machine learning model may be implemented using user suggestion system 144. As described above, in some embodiments the change in time spent in the queue may correspond to a change in position in the queue. For example, the queue may track position. In some embodiments, a tracked position may be used when timing data is not applicable or available. When queue management system 140 determines the predicted time spent in the queue, one or more potential values for the change in time spent in queue, and/or respective exchange amounts, queue management system 140 may transmit a data packet via network 130 to first queuing device 110. In some embodiments, these may be updated values similar to 605 and/or 610 as described with reference to FIG. 6.

Upon determining the predicted time spent in the queue, one or more potential values for the change in time spent in queue, and/or respective exchange amounts, first queuing device 110 may display one or more of these values on user interface 112. This may occur in a manner similar to 520 as described with reference to FIGS. 5 and 615 as described with reference to FIG. 6.

At 710, first queuing device 110 may receive, at the user interface 112, an indication of a selected change in time spent in a queue and/or a respective exchange amount corresponding to the selected change in time. This may occur in a manner similar to 330, 525, and/or 620 as described with reference to FIGS. 3, 5, and 6 respectively. The user may select the desired change in time spent in the queue and respective exchange amount. In some embodiments, first queuing device 110 may be controlled by an autonomously operating computing device, such as a self-driving car, which may indicate the selection without input from the user. For example, first queuing device 110 may be preconfigured to perform the selection.

At 715, first queuing device 110 identifies one or more other queuing devices for exchanging queue positions to achieve the selected change in time spent in the queue. First queuing device 110 and/or queue management system 140 may perform this determination. For example, queue management system 140 may track the one or more other queuing devices included in the queue. This may be the other vehicles on the roadway to first queuing device's 110 target destination. In some embodiments, queue management system 140 may transmit identifications corresponding to the one or more other queuing devices to first queuing device 110. First queuing device 110 may use these identifications to confirm that the one or more other queuing devices have exchanged queue positions. This may occur in a manner similar to 210 and/or 215 as described with reference to FIG. 2A and/or 335 as described with reference to FIG. 3.

First queuing device 110 may also determine portions of the exchange amount for exchanges in position in the queue. The portions of the exchange amount may be proportional to the portion of the change in time spent in the queue achieved by the exchange in position. In some embodiments, one or more exchange amounts may be microtransaction amounts. This may allow multiple successive transactions and/or exchanges in position in the queue with various other queuing devices in the same queue. Microtransactions may allow first queuing device 110 to achieve the selected change in time spent in the queue by exchanging positions in the queue with multiple different users and/or respective queuing devices.

At 720, first queuing device 110 determines that first queuing device 110 and the one or more other queuing devices have exchanged queue positions. In some embodiments, this may occur in a manner similar to 215, 240, 335, and/or 425 as described with reference to FIGS. 2A, 2B, 3, and 4. For example, the exchange may be a change in relative physical position of first queuing device 110 and second queuing device 120 in the queue, as described in FIGS. 2A, 2B, and 3. In some embodiments, the exchange in position may be an exchange in the position of first queuing device 110 in the queue for the position of second queuing device 120 in an electronic queue, as described in FIG. 4.

At 725, first queuing device 110 transfers the respective exchange amount from a first digital wallet corresponding to the first queuing device 110 to one or more digital wallets respectively corresponding to the one or more other queuing devices. This may occur in a manner similar to 220, 245, 340, and/or 430 as described with reference to FIGS. 2A, 2B, 3, and 4. Once the exchange in position has been verified, the exchange amount may be transferred from a first digital wallet to a second digital wallet. Methods 200A, 200B, 300, and 400, describe the first digital wallet corresponding to first queuing device 110 and one or more digital wallets corresponding to one or more queuing devices in the queue. In some embodiments, the one or more digital wallets receiving portions of the exchange amount may have indicated that they are willing to spend more time in the queue and/or are willing to yield positions in the queue to first queuing device 110. In some embodiments, 715, 720, and 725 may be executed repeatedly to achieve the selected change in time in the queue. This may also occur if a user changes the desired time spent in queue. In some embodiments, the selected change in time spent in the queue and/or exchange amount may deviate from the originally selected amount. For example, the selected change in time spent in queue may no longer be valid and/or be rescinded. In this case, first queuing device 110 may follow method 600 to resolve the deviation.

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806. In some embodiments, processor 804 may include an encryption system. This may be used to provide transaction security and/or to pass secure and/or trusted data. In some embodiments, the encryption system may be a physical secure element chip. The encryption system may also use a kernel and/or other certified software element to provide encryption and/or decryption of communications and/or messages. Such functionality may be implemented using one or more processors, such as processor 804.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, cither exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer implemented method, comprising:
retrieving, at a first queuing device, user application data corresponding to one or more applications installed on the first queuing device;
determining the first queueing device is entering a queue based on the user application data;
determining a queue position of the first queueing device in the queue using data from one or more other queuing devices in the queue, wherein the data comprises location data or sensor data from the one or more other queueing devices;
determining, using the user application data and a queue exchange machine learning model, a predicted time spent in the queue for the first queuing device from the queue position, one or more potential changes in time spent in the queue respectively corresponding to an exchange in the queue position with each queuing device of the one or more other queuing devices, and one or more exchange amounts respectively corresponding to each of the one or more potential changes in time spent in the queue;
displaying, at a user interface of the first queuing device, the one or more potential changes in time spent in the queue and the one or more exchange amounts;
receiving an interaction with the user interface selecting a particular change in time spent in the queue and an exchange amount from the one or more exchange amounts corresponding to the particular change in time, wherein the particular change in time corresponds to an exchange in queue positions with a respective other queuing device of the one or more other queueing devices;
verifying that the first queuing device has exchanged queue positions with the respective other queuing device, wherein the verifying further comprises using at least one position sensor to determine a relative movement between the first queuing device and the respective other queuing device, wherein the relative movement indicates that the first queuing device and the respective other queuing device have exchanged physical positions, and wherein the exchanged physical positions correspond to the exchanged queue positions; and
in response to the verifying, transferring the exchange amount from a digital wallet corresponding to the first queuing device to one or more digital wallets respectively corresponding to the one or more other queuing devices.

2. The computer implemented method of claim 1, wherein the user application data includes data from a calendar application.

3. The computer implemented method of claim 1, wherein the user application data includes data from a trip planning application.

4. The computer implemented method of claim 1, wherein the determining further comprises:
transmitting the user application data to a queue management system that applies the queue exchange machine learning model; and
receiving, from the queue management system, the one or more potential changes in time spent in the queue and the one or more exchange amounts respectively corresponding to each of the one or more potential changes in time spent in the queue.

5. The computer implemented method of claim 1, wherein the determining further comprises:
determining a likelihood of success associated with each of the one or more potential changes in time based on queue data from the one or more other queuing devices in the queue.

6. The computer implemented method of claim 1, further comprising:
receiving, at the first queuing device and from a queue management system, a notification message indicating that the particular change in time selected and the exchange amount have been rescinded; and
displaying, at the user interface, the notification message and a prompt requesting an updated change in time selection or an updated exchange amount selection.

7. (canceled)

8. A system, comprising:
a user interface;
a memory; and
at least one processor coupled to the user interface and the memory and configured to:
retrieve user application data corresponding to one or more applications installed in the memory;
determine the first queueing device is entering a queue based on the user application data;
determine a queue position of the first queueing device in the queue using data from one or more other queuing devices in the queue, wherein the data comprises location data or sensor data from the one or more other queueing devices;
determine, using the user application data and a queue exchange machine learning model, a predicted time spent in the queue for the first queuing device from the queue position, one or more potential changes in time spent in the queue respectively corresponding to an exchange in the queue position with each queuing device of the one or more other queuing devices, and one or more exchange amounts respectively corresponding to each of the one or more potential changes in time spent in the queue;
display, at the user interface, the one or more potential changes in time spent in the queue and the one or more exchange amounts;
receive an interaction with the user interface selecting a particular change in time spent in the queue and an exchange amount from the one or more exchange amounts corresponding to the particular change in time, wherein the particular change in time corresponds to an exchange in queue positions with a respective other queuing device of the one or more other queueing devices;
verify that the system has exchanged queue positions with the respective other queuing device, wherein to verify the exchanged queue positions, the at least one processor is further configured to use at least one position sensor to determine a relative movement between the first queuing device and the respective other queuing device, wherein the relative movement indicates that the first queuing device and the respective other queuing device have exchanged physical positions, and wherein the exchanged physical positions correspond to the exchanged queue positions; and
in response to the verifying, transfer the exchange amount from a digital wallet corresponding to the system to one or more digital wallets respectively corresponding to the one or more other queuing devices.

9. The system of claim 8, wherein the user application data includes data from a calendar application.

10. The system of claim 8, wherein the user application data includes data from a trip planning application.

11. The system of claim 8, wherein to determine the one or more potential changes in time spent in the queue and the one or more exchange amounts, the at least one processor is further configured to:
transmit the user application data to a queue management system that applies the queue exchange machine learning model; and
receive, from the queue management system, the one or more potential changes in time spent in the queue and the one or more exchange amounts respectively corresponding to each of the one or more potential changes in time spent in the queue.

12. The system of claim 8, wherein to determine the one or more potential changes in time spent in the queue and the one or more exchange amounts, the at least one processor is further configured to:
determine a likelihood of success associated with each of the one or more potential changes in time based on queue data from the one or more other queuing devices in the queue.

13. The system of claim 8, wherein the at least one processor is further configured to:
receive, from a queue management system, a notification message indicating that the particular change in time selected and the exchange amount have been rescinded; and
display, at the user interface, the notification message and a prompt requesting an updated change in time selection or an updated exchange amount selection.

14. (canceled)

15. A non-transitory computer-readable device having instructions stored thereon that, when executed by at least one computing device, cause the at least one computing device to perform operations comprising:
retrieving, at the at least one computing device, user application data corresponding to one or more applications installed on the at least one computing device;
determining the first queueing device is entering a queue based on the user application data;
determining a queue position of the first queueing device in the queue using data from one or more other queuing devices in the queue, wherein the data comprises location data or sensor data from the one or more other queueing devices;
determining, using the user application data and a queue exchange machine learning model, a predicted time spent in the queue for the first queuing device from the queue position, one or more potential changes in time spent in the queue respectively corresponding to an exchange in the queue position with each queuing device of the one or more other queuing devices, and one or more exchange amounts respectively corresponding to each of the one or more potential changes in time spent in the queue;
displaying, at a user interface of the at least one computing device, the one or more potential changes in time spent in the queue and the one or more exchange amounts;
receiving an interaction with the user interface selecting a particular change in time spent in the queue and an exchange amount from the one or more exchange amounts corresponding to the particular change in time, wherein the particular change in time corresponds to an exchange in queue positions with a respective other queuing device of the one or more other queueing devices;
verifying that the at least one computing device has exchanged queue positions with the respective other queuing device, wherein the verifying further comprises using at least one position sensor to determine a relative movement between the first queuing device and the respective other queuing device, wherein the relative movement indicates that the first queuing device and the respective other queuing device have exchanged physical positions, and wherein the exchanged physical positions correspond to the exchanged queue positions; and
in response to the verifying, transferring the exchange amount from a digital wallet corresponding to the at least one computing device to one or more digital wallets respectively corresponding to the one or more other queuing devices.

16. The non-transitory computer-readable device of claim 15, wherein the user application data includes data from a calendar application or data from a trip planning application.

17. The non-transitory computer-readable device of claim 15, wherein the determining further comprises:
transmitting the user application data to a queue management system that applies the queue exchange machine learning model; and
receiving, from the queue management system, the one or more potential changes in time spent in the queue and the one or more exchange amounts respectively corresponding to each of the one or more potential changes in time spent in the queue.

18. The non-transitory computer-readable device of claim 15, wherein the determining further comprises:
determining a likelihood of success associated with each of the one or more potential changes in time based on queue data from the one or more other queuing devices in the queue.

19. The non-transitory computer-readable device of claim 15, wherein the operations further comprise:
receiving, at the at least one computing device and from a queue management system, a notification message indicating that the particular change in time selected and the exchange amount have been rescinded; and
displaying, at the user interface, the notification message and a prompt requesting an updated change in time selection or an updated exchange amount selection.

20. (canceled)

21. The computer implemented method of claim 1, wherein the at least one position sensor comprises a position sensor of the first queueing device or one or more position sensors respectively corresponding to each of the one or more other queueing devices.

22. The system of claim 8, wherein the at least one position sensor comprises a position sensor of the first queueing device or one or more position sensors respectively corresponding to each of the one or more other queueing devices.

23. The non-transitory computer-readable device of claim 15, wherein the at least one position sensor comprises a position sensor of the first queueing device or one or more position sensors respectively corresponding to each of the one or more other queueing devices.
